(19) United States
(12) Patent Application Publication
(10) Pub. No.: US 2026/0052000 A1
(43) Pub. Date: Feb. 19, 2026

(54) SBFD-AWARE UE WITH SINGLE DL SUBBAND

(71) Applicant: QUALCOMM Incorporated, San Diego, CA (US)

(72) Inventors: Muhammad Sayed Khairy ABDELGHAFFAR, San Jose, CA (US); Ahmed Attia ABOTABL, San Diego, CA (US); Abdelrahman Mohamed IBRAHIM, San Diego, CA (US)

(21) Appl. No.: 19/287,654

(22) Filed: Jul. 31, 2025

Related U.S. Application Data
(60) Provisional application No. 63/684,300, filed on Aug. 16, 2024.

(51) Int. Cl. H04L 5/14; H04W 72/231

(52) U.S. Cl. CPC H04L 5/14; H04W 72/231

(57) ABSTRACT

A method for wireless communication at a user equipment (UE) and related apparatus are provided. In the method, the UE reports to a network entity a capability associated with one downlink subband among multiple downlink subbands included in a downlink bandwidth part (BWP). The multiple downlink subbands correspond to a first time-domain resource. The first time-domain resource may be a subband full duplex (SBFD) symbol or an SBFD slot. The UE further communicates with the network entity using a selected downlink subband from the multiple downlink subbands for one or more time-domain resources including the first time-domain resource.

### CROSS REFERENCE TO RELATED APPLICATION(S)

This application claims the benefit of and priority to U.S. Provisional Application Ser. No. 63/684,300, entitled “SBFD-AWARE UE WITH SINGLE DL SUBBAND” and filed on Aug. 16, 2024, which is expressly incorporated by reference herein in its entirety.

### TECHNICAL FIELD

The present disclosure relates generally to communication systems and, more particularly, to subband full duplex (SBFD) aware user equipment (UE) that operates using a single downlink subband.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard, and some aspects of future wireless communication technologies may be based on aspects of 5G NR. Some aspects of later wireless communication, such as 6G or others, may be based on aspects of 5G NR and/or 4G LTE. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor may be configured to report, to a network entity, a capability associated with one downlink subband among multiple downlink subbands included in a downlink bandwidth part (BWP), where the multiple downlink subbands correspond to a first time-domain resource; and communicate with the network entity using a selected downlink subband from the multiple downlink subbands for one or more time-domain resources including the first time-domain resources.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor may be configured to receive a capability associated with one downlink subband among multiple downlink subbands included in a downlink BWP, where the multiple downlink subbands correspond to a first time-domain resource; and communicate with a UE using a selected downlink subband from the multiple downlink subbands corresponding to one or more time-domain resources including the first time-domain resource.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 illustrates examples of in-band full-duplex (IBFD) and sub-band frequency divisional duplex resources.

FIG. 5 is a diagram illustrating an example of sub-band full-duplex (SBFD) operation.

FIG. 6 is a diagram illustrating an example of multiple downlink subbands available for a subband full duplex (SBFD) aware user equipment (UE).

FIG. 7A is a diagram illustrating an example of a fixed or semi-static subband scheduling in accordance with various aspects of the present disclosure.

FIG. 7B is a diagram illustrating an example of a dynamic subband scheduling in accordance with various aspects of the present disclosure.

FIG. 8 is a diagram illustrating an example of available channel state information-reference signal (CSI-RS) resources in accordance with various aspects of the present disclosure.

FIG. 9 is a diagram illustrating an example of CSI reporting subbands used for a CSI-RS report in accordance with various aspects of the present disclosure.

FIG. 10 is a diagram illustrating example resource block groups (RBGs) used for physical downlink shared channel (PDSCH) scheduling in accordance with various aspects of the present disclosure.

FIG. 11A is a diagram illustrating an example of physical resource blocks (PRGs) scheduled for PDSCH in accordance with various aspects of the present disclosure.

FIG. 11B is a diagram illustrating an example of PRGs scheduled for PDSCH in accordance with various aspects of the present disclosure.

FIG. 12 is a diagram illustrating an example of wireless communication using one single downlink subband in multiple downlink subbands in accordance with various aspects of the present disclosure.

FIG. 13 is a call flow diagram illustrating a method of wireless communication in accordance with various aspects of the present disclosure.

FIG. 14 is a flowchart illustrating methods of wireless communication at a UE in accordance with various aspects of the present disclosure.

FIG. 15 is a flowchart illustrating methods of wireless communication at a UE in accordance with various aspects of the present disclosure.

FIG. 16 is a flowchart illustrating methods of wireless communication at a network entity in accordance with various aspects of the present disclosure.

FIG. 17 is a flowchart illustrating methods of wireless communication at a network entity in accordance with various aspects of the present disclosure.

FIG. 18 is a diagram illustrating an example of a hardware implementation for an example apparatus and/or UE.

FIG. 19 is a diagram illustrating an example of a hardware implementation for an example network entity.

### DETAILED DESCRIPTION

In wireless communication, subband full duplex (SBFD) is a technology that allows the simultaneous transmission and reception of signals on different frequency subbands within the same communication channel. An SBFD-aware user equipment (UE) refers to a UE that can support SBFD operations and/or supports the use of information about the SBFD operation of a network node or other device. For example, an SBFD-aware UE may communicate with a network node, such as a base station, where the base station communicates in a full-duplex manner using SBFD resources, while the UE may operate in a half-duplex or full-duplex mode. The UE may support the reception of information indicating the network node's use of SBFD resources. While multiple downlink subbands may be available for SBFD-aware UEs for downlink communication, some SBFD-aware UEs may choose to use a single downlink subband (also referred to herein as one downlink subband or one single downlink subband) for downlink communication due to limitations such as insufficient capability or bandwidth capacity or because filtering is simpler with a single subband compared to multiple subbands. To accommodate SBFD-aware UEs that prefer using a single downlink subband, networks may provide a wider downlink bandwidth part (BWP) in the downlink or flexible symbols but limit scheduling within the UE's downlink BWP to one of the multiple downlink subbands. Example aspects presented herein provide methods and apparatus that support the operation of SBFD-aware UEs using a single downlink subband.

Various aspects relate generally to wireless communication. Some aspects more specifically relate to the SBFD-aware UE that operates using a single downlink subband in SBFD symbols. In some examples, a UE may report to a network entity a capability associated with one downlink subband among multiple downlink subbands included in a downlink bandwidth part (BWP). The multiple downlink subbands may correspond to a first time-domain resource. The UE may further communicate with the network entity using a selected downlink subband from multiple downlink subbands for one or more time-domain resources including the first time-domain resource. In some examples, the UE may use the selected downlink subband for receiving a data or control signal when the UE is in a radio resource control (RRC) connected state. In some examples, the UE may use the selected downlink subband for small data transmission (SDT) when the UE is in an RRC idle state or an RRC inactive state. In some examples, the selected subband may be a semi-statically fixed downlink subband across multiple SBFD symbols or SBFD slots. In some examples, the selected downlink subband may be dynamically changed for different SBFD symbols or SBFD slots.

Particular aspects of the subject matter described in this disclosure can be implemented to realize one or more of the following potential advantages. In some examples, by enabling the use of a single downlink subband for an SBFD-aware UE where multiple downlink subbands are available, the described techniques can be used to ensure broader compatibility across various device types within the network, including UEs with limited processing power or spectrum capability. In some examples, by providing both semi-static and dynamic scheduling options for selecting the single downlink subband, the described techniques allow flexible adjustment of the single downlink subband based on network conditions and UE capabilities, thereby improving the overall network efficiency and performance. In some examples, by allowing a simpler downlink filtering process on a single downlink subband, compared to using notch filters across multiple subbands, the described techniques significantly reduce the computational load on the UE.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, 6G systems, or other communication systems, may be arranged in multiple manners with various components or constituent parts. As an example, in a wireless communication network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

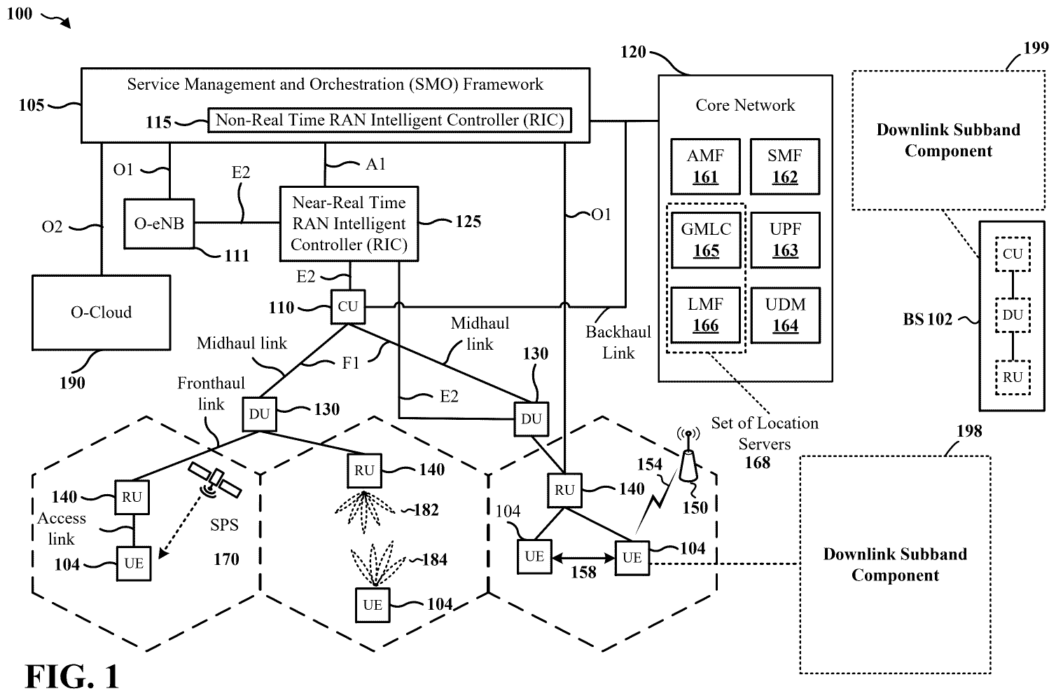

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. An operating band for these mid-band frequencies may have the frequency range designation FR3 (7.125 GHz-24.25 GHZ), for example. Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation, or other wireless communication operation, beyond 52.6 GHz. For example, three higher operating bands have been identified as frequency range designations FR2-2 (52.6 GHz-71 GHz), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a downlink subband component 198. The downlink subband component 198 may be configured to report, to a network entity, a capability associated with one downlink subband among multiple downlink subbands included in a downlink BWP, where the multiple downlink subbands correspond to a first time-domain resource; and communicate with the network entity using a selected downlink subband from the multiple downlink subbands for one or more time-domain resources including the first time-domain resource. In certain aspects, the base station 102 may include a downlink subband component 199. The downlink subband component 199 may be configured to receive a capability associated with one downlink subband among multiple downlink subbands included in a downlink BWP, where the multiple downlink subbands correspond to the first time-domain resource; and communicate with the UE using a selected downlink subband from the multiple downlink subbands corresponding to one or more time-domain resources including the first time-domain resource. Although the following description may give examples based on 5G NR to illustrate concepts relating to wireless communication, the concepts described herein may be applicable to other similar areas, such as LTE, LTE-A, CDMA, GSM, 6G, and other wireless technologies.

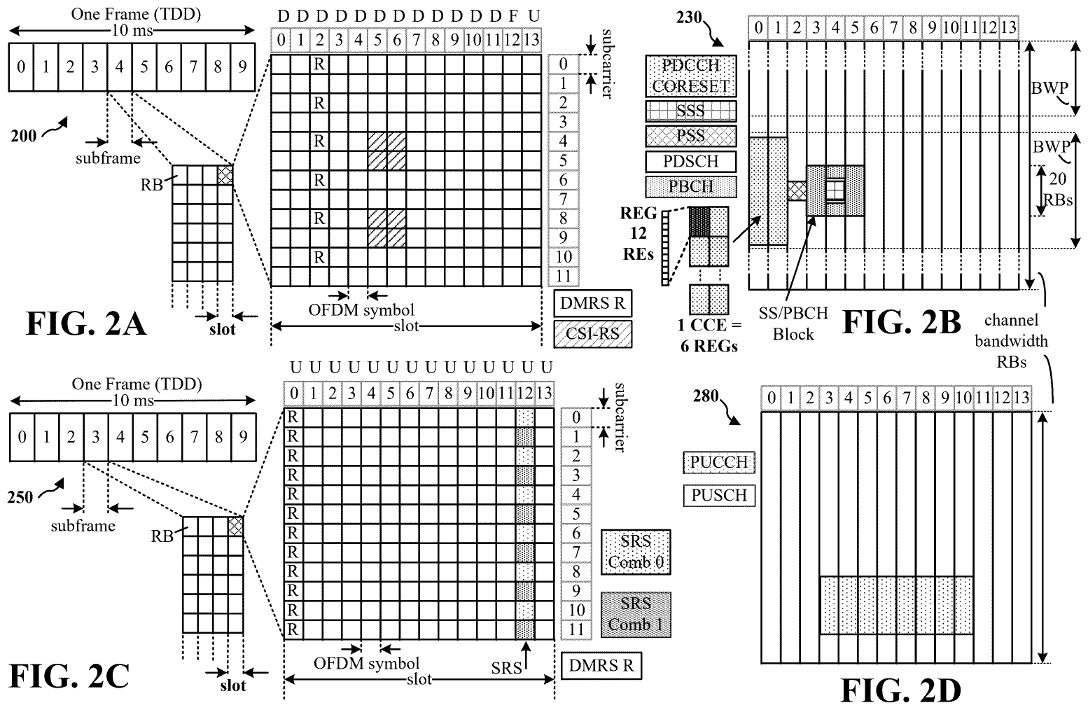

FIG. 2A is a diagram 200 illustrating an example of a first subframe within a frame structure. FIG. 2B is a diagram 230 illustrating an example of DL channels within a subframe. FIG. 2C is a diagram 250 illustrating an example of a second subframe within a frame structure. FIG. 2D is a diagram 280 illustrating an example of UL channels within a subframe. The examples in FIGS. 2A-2D show example aspects of a frame structure based on 5G NR to illustrate the concept of a frame structure and wireless communication based on a frame structure. Various aspects described in connection with FIGS. 2A-2D may also be used in connection with other wireless communication technologies, such as 6G among other examples. The frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

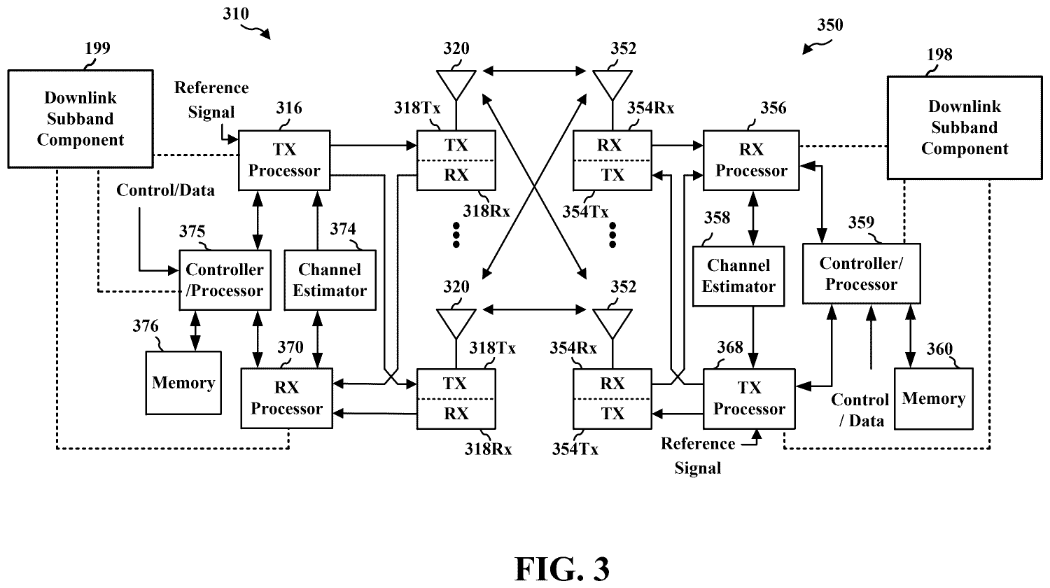

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the downlink subband component 198 of FIG. 1.

At least one of the TX processor 316, the RX processor 370, and the controller/processor 375 may be configured to perform aspects in connection with the downlink subband component 199 of FIG. 1.

The present disclosure provides methods and apparatus that enable an SBFD-aware UE to use one single downlink subband from multiple downlink subbands for downlink communication.

Wireless communication systems may be configured to share available system resources and provide various telecommunication services (e.g., telephony, video, data, messaging, broadcasts, etc.) based on multiple-access technologies that support communication with multiple users. Full duplex operation, in which a wireless device exchanges uplink and downlink communication that overlaps in time, may enable more efficient use of the wireless spectrum. Full duplex operation may include simultaneous transmission and reception in the same frequency range. In some examples, the frequency range may be an mmW frequency range, e.g., frequency range 2 (FR2). In some examples, the frequency range may be a sub-6 GHz frequency range, e.g., frequency range 1 (FR1). Full duplex communication may reduce latency. As one example, full duplex operation may enable a base station to transmit a downlink signal in an uplink-only slot, which can reduce the latency for the downlink communication. Full duplex communication may improve spectrum efficiency, e.g., spectrum efficiency per cell or per UE. Full duplex communication may enable more efficient use of wireless resources.

There may be various modes of full duplex communication. Full duplex communication supports the transmission and reception of information over the same frequency band in a manner that overlaps in time. In this manner, spectral efficiency may be improved with respect to the spectral efficiency of half-duplex communication, which supports the transmission or reception of information in one direction at a time without overlapping uplink and downlink communication

In some aspects, a first base station may transmit and receive full duplex communication with a first UE and a second UE that transmit or receive half-duplex communication in a half-duplex mode. In some aspects, a base station may transmit and receive full-duplex communication with a UE that operates in a full-duplex mode.

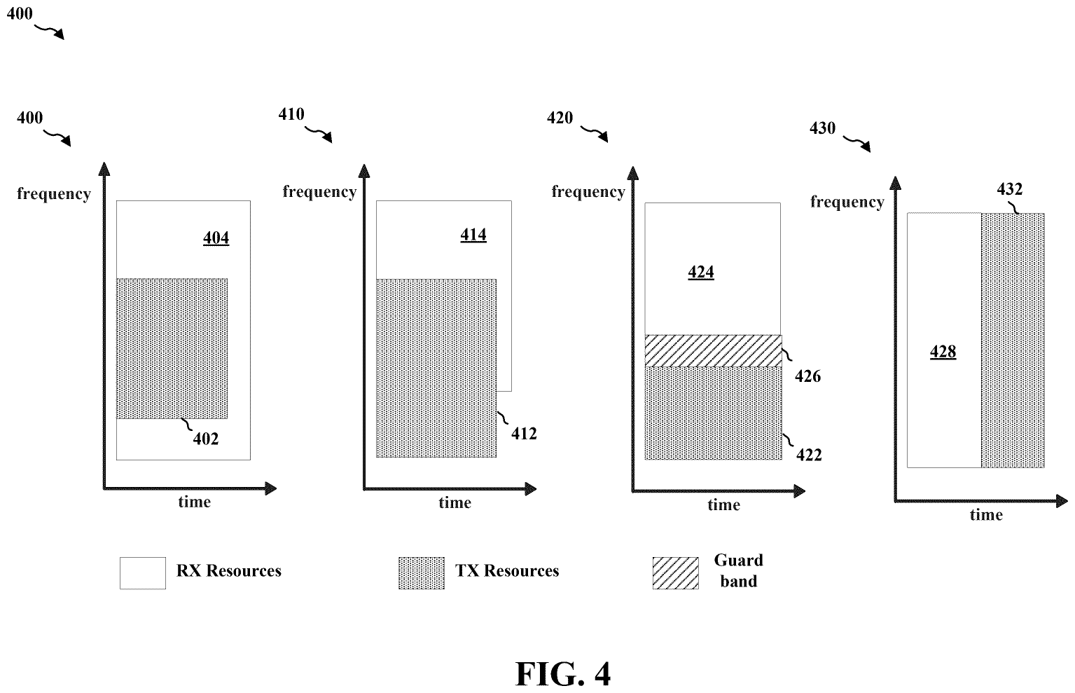

Full duplex communication may be in the same frequency band. The uplink and downlink communication may be in different frequency sub-bands, in the same frequency sub-band, or in partially overlapping frequency sub-bands. FIG. 4 illustrates a first example 400 and a second example 410 of in-band full-duplex (IBFD) resources and a third example 420 of SBFD resources. In IBFD, signals may be transmitted and received in overlapping times and overlapping in frequency. As shown in the first example 400, a time and frequency allocation of transmission resources 402 may fully overlap with a time and frequency allocation of reception resources 404. In the second example 410, a time and frequency allocation of transmission resources 412 may partially overlap with a time and frequency of allocation of reception resources 414.

IBFD is in contrast to sub-band FDD, where transmission and reception resources may overlap in time using different frequencies, as shown in the third example 420. In the third example 420, the UL, the transmission resources 422 are separated from the reception resources 424 by a guard band 426. The guard band may be frequency resources, or a gap in frequency resources, provided between the transmission resources 422 and the reception resources 424. Separating the transmission frequency resources and the reception frequency resources with a guard band may help to reduce self-interference. Transmission resources and reception resources that are immediately adjacent to each other may be considered as having a guard bandwidth of 0. As an output signal from a wireless device may extend outside the transmission resources, the guard band may reduce interference experienced by the wireless device. Sub-band FDD may also be referred to as “flexible duplex.”

A fourth example 430 illustrates an example of half-duplex resources in which the reception resources 428 do not overlap in time with the transmission resources 432.

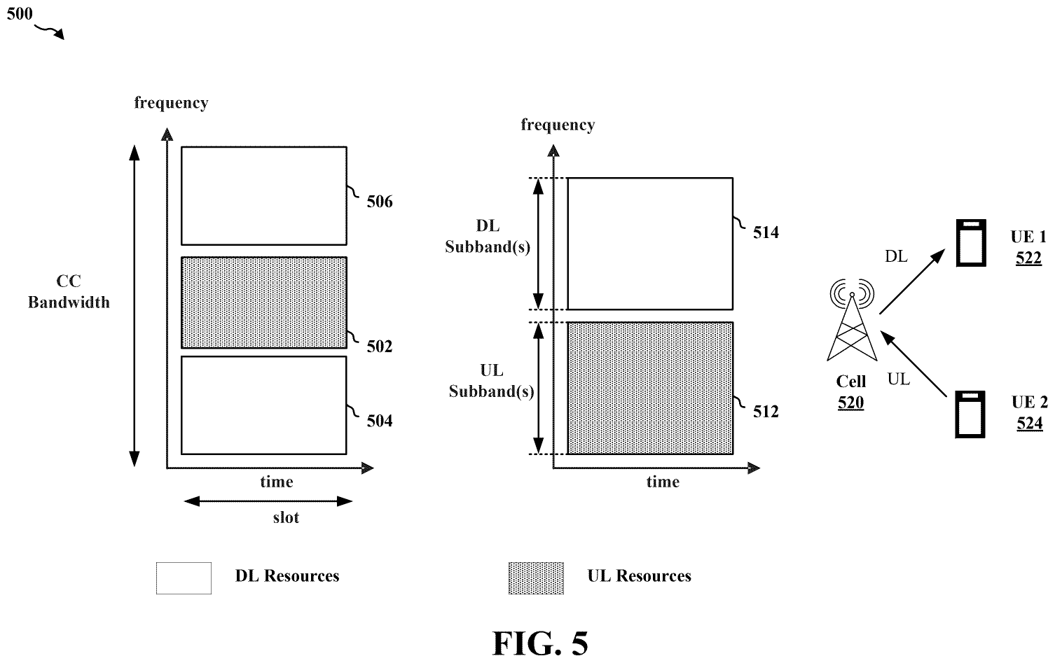

FIG. 5 is a diagram 500 illustrating an example of SBFD operation. As shown in FIG. 5, a cell 520 may have DL communication with one UE (e.g., UE 1 522), and simultaneously have UL communication with another UE (e.g., UE 2 524) on the same slot. In one example, the DL communication with UE 1 522 may utilize DL resources 504, 506, and the UL communication with UE 2 524 may utilize UL resources 502. In another example, the DL communication with UE 1 522 may utilize DL resources 514, and the UL communication with UE 2 524 may utilize UL resources 512.

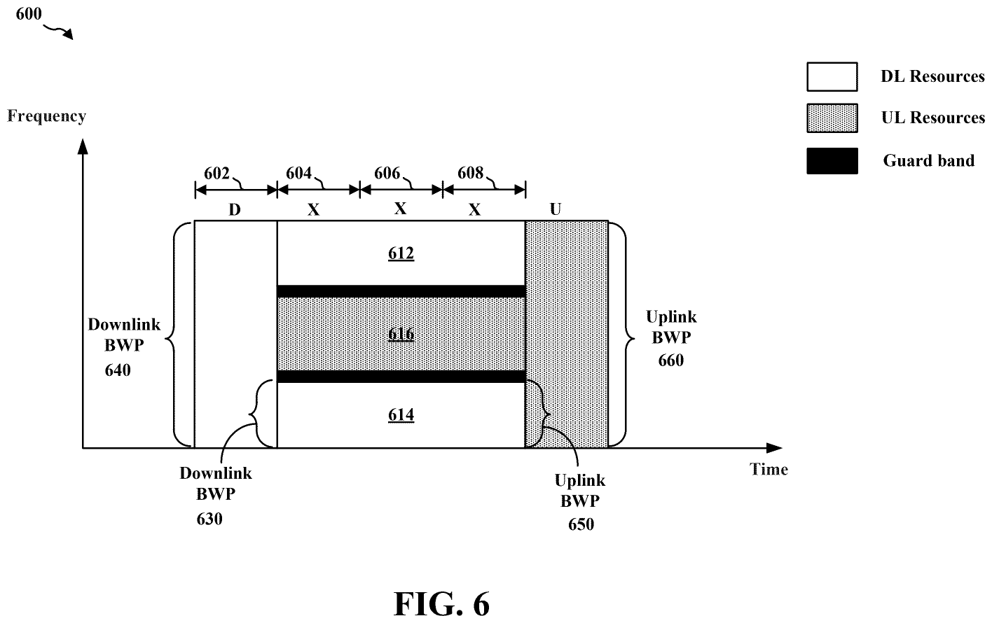

While multiple downlink subbands may be available for SBFD-aware UEs for downlink communication, some SBFD-aware UEs may choose to use a single downlink subband. For example, lower-capability UEs may not support some enhancements for downlink scheduling across two downlink subbands, including the capability to handle non-contiguous channel state information-reference signals (CSI-RS) and physical downlink shared channel (PDSCH) scheduling across two downlink subbands or a wideband configuration. In some examples, UEs may prefer a simpler filtering process (e.g., a low pass filtering process) that can be used on a single downlink subband rather than a complex notch filter for multiple downlink subbands. In some examples, UEs with limited capabilities, such as reduced capability UEs or RedCap UEs, may have limited bandwidth capacities, making a single downlink subband more suitable for their operations. Hence, these UEs may use a signal downlink subband for downlink communication. FIG. 6 is a diagram 600 illustrating an example of multiple downlink subbands available for an SBFD-aware UE. In FIG. 6, multiple downlink subbands (e.g., downlink subbands 612, 614) are available over various time-domain resources 604, 606, and 608. The time-domain resources 604, 606, and 608 may be, for example, SBFD symbols or slots, and the multiple downlink subbands (e.g., downlink subbands 612, 614) may span multiple of these symbols or slots. A UE may choose to use one of the downlink subbands (e.g., downlink subband 614) for its downlink communication.

To accommodate SBFD-aware UEs that choose to use a single downlink subband, the network may, in one configuration, limit the downlink bandwidth part (DL-BWP) to match the one downlink subband, such as the largest downlink subband. For example, the network may configure the DL-BWP 630 based on the one downlink subband 614.

This approach, however, may limit the downlink scheduling in non-SBFD (e.g., downlink or flexible) symbols, such as downlink symbol 602, to a smaller BWP size and may impose limitations on the uplink BWP (UL-BWP) configuration (e.g., reduce the uplink BWP from uplink BWP 660 to uplink BWP 650) due to the alignment on the center frequencies for the uplink BWP (e.g., uplink BWP 650) with the downlink BWP (e.g., downlink BWP 640).

In another configuration, the network may provide a wider BWP (e.g., downlink BWP 640) in the downlink or flexible symbols (e.g., downlink symbol 602). However, the network may limit scheduling within the UE's downlink BWP (e.g., downlink BWP 640) in SBFD symbols to one downlink subband (e.g., downlink subband 614) of the multiple (e.g., two) downlink subbands. This would allow a wider downlink BWP (e.g., downlink BWP 640) in the downlink or flexible symbols and would not impose restrictions on the uplink BWP configuration. The network may implement these scheduling restrictions in a semi-static or dynamic manner. Example aspects presented herein provide methods and apparatus that support the operation of SBFD-aware UEs using a single downlink subband (e.g., downlink subband 614) in a wider BWP (e.g., downlink BWP 640).

In some aspects, an SBFD-aware UE may report its capability of using one single downlink subband in a first time-domain resource that includes multiple downlink subbands. For example, the first time-domain resource may include one or more SBFD symbols or one or more slots. In some examples, the multiple downlink subbands may include two downlink subbands (e.g., downlink subbands 612, 614) in a downlink-uplink-downlink frequency pattern (e.g., the frequency pattern that includes downlink subband 612, uplink subband 616, and downlink subband 614). In some examples, this capability may apply to data scheduling and common signal receptions for UEs in a radio resource control (RRC) connected state. In some examples, this capability may apply to small data transmission (SDT) for UEs in an RRC idle state or an RRC inactive state.

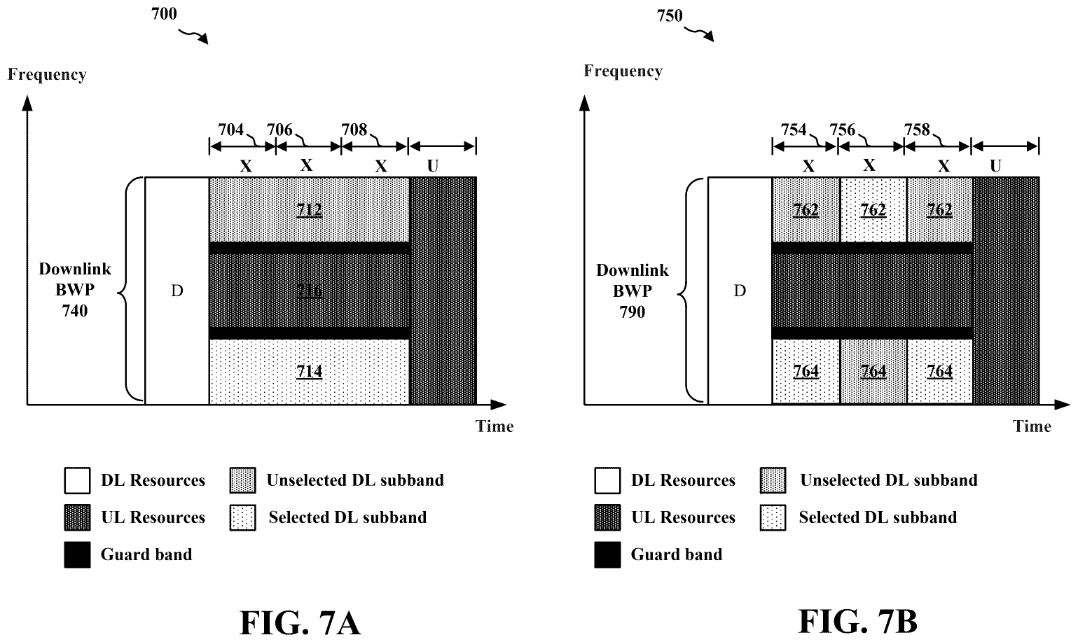

The UE's capability to use one single subband may be implemented in various ways. In some examples, the scheduling for using one single subband may be a fixed or semi-static subband scheduling, which may facilitate simpler and more reliable filtering processes (e.g., low pass filtering) on the one single subband. FIG. 7A is a diagram 700 illustrating an example of a fixed or semi-static subband scheduling in accordance with various aspects of the present disclosure. In FIG. 7A, the selection of downlink subband 714 as the subband for downlink communication may be fixed across multiple time-domain resources (e.g., 704, 706, 708).

In some examples, the one subband used for downlink communication may be dynamically determined and may be changed among different symbols or slots. FIG. 7B is a diagram 750 illustrating an example of a dynamic subband scheduling in accordance with various aspects of the present disclosure. In FIG. 7B, the dynamic subband scheduling allows the one downlink subband to be selected for downlink communication, and the selected downlink subband may change across the time-domain resources (e.g., 704, 706, 708). For example, between the two available downlink subbands 762 and 764, downlink subband 762 may be selected for downlink communication for time-domain resource (e.g., a symbol or slot) 756, while downlink subband 764 may be selected for time-domain resources (e.g., symbols or slots) 754 and 758. In scenarios where dynamic scheduling is used, the UE may report the minimum period for switching before the UE can switch to another downlink subband, as well as the transition period for switching from operating in one downlink subband to another downlink subband. For example, in FIG. 7B, the UE may report the minimum period for switching from downlink subband 764 to downlink subband 762, and the UE may switch to downlink subband 762 after using the downlink subband 764 for a period that is longer than the minimum period.

In some aspects, the selection or identification of the single downlink subband used for downlink communication may be managed through various approaches. In some examples, the selected downlink subband may be semi-static fixed for each BWP based on a radio resource control (RRC) configuration. For example, in FIG. 7A, the downlink subband 714 for BWP 740 may be semi-static fixed based on an RRC configuration. This semi-static fixed configuration may enable simple filtering, such as low pass filtering, on the selected downlink subband (e.g., downlink subband 714). In some examples, this semi-static RRC configuration may specify the lower downlink subband or upper downlink subband (in terms of the frequency range) as the selected downlink subband. In some examples, this semi-static RRC configuration may specify a downlink subband with a higher number of physical resource blocks (PRBs) within the UE's downlink BWP (e.g., downlink BWP 740) as the selected downlink subband. In some examples, this semi-static RRC configuration may specify a downlink subband that contains important common signaling, such as the synchronization signal block (SSB) or system information block 1 (SIB1), as the selected downlink subband.

In some examples, selecting the one downlink subband for downlink communication may be achieved using a dynamic or variable approach, where the network may schedule the downlink communication to be restricted to one of the downlink subbands. In some examples, the network (e.g., a base station) may explicitly indicate the selected downlink subband using downlink control information (DCI). In some examples, the network (e.g., a base station) may implicitly indicate the selected downlink subband based on the start resource block (RB) of the scheduled downlink signal or channel. This dynamic identification may accommodate SBFD-aware UEs with lower capabilities that may not support channel state information-reference signals (CSI-RS) or physical downlink shared channel (PDSCH) across multiple (e.g., two) downlink subbands. In some examples, when switching from one downlink subband to another, such as from downlink subband 764 at 754 to downlink subband 762 at 756, the UE may adhere to a minimum switching period, determined in terms of slots or symbols. For example, the UE may change the downlink subband from downlink subband 764 to downlink subband 762 if the switching time it was given is longer than the minimum switch period. The minimum switch period may be determined based on the UE's capabilities.

In some aspects, the usable downlink physical resource blocks (PRBs) for the single downlink subband selected for downlink communication may be determined based on the intersection between the downlink BWP and the single downlink subband. In some examples, when the single downlink subband is a semi-static fixed subband (e.g., downlink subband 714), the usable downlink PRBs may be determined as the intersection of the semi-statically indicated, cell-specific downlink subband (e.g., downlink subband 714) and the active downlink BWP (e.g., downlink BWP 740) in the time-domain resources (e.g., SBFD symbols or slots). In some examples, when the single downlink subband is a dynamic or variable downlink subband (e.g., downlink subband 764 at 754, downlink subband 762 at 756), the usable downlink PRBs may be determined as the intersection between the cell-specific downlink subbands (e.g., downlink subbands 762 and 764) and the active downlink BWP (e.g., downlink BWP 790) in the time-domain resources (e.g., SBFD symbols or slots).

In some examples, when the selected single downlink subband is a dynamic or variable downlink subband (e.g., downlink subband 764 at 754, downlink subband 762 at 756), SBFD-aware UEs may not be scheduled with non-contiguous PRBs that span across different downlink subbands (e.g., across downlink subbands 762 and 764). Instead, the SBFD-aware UEs may be scheduled within the usable PRBs of one of the cell-specific downlink subbands. For example, instead of spanning non-contiguous PRBs across downlink subbands 762 and 764, SBFD-aware UEs may be scheduled within the usable PRBs of one downlink subband, such as downlink subband 762 or 764.

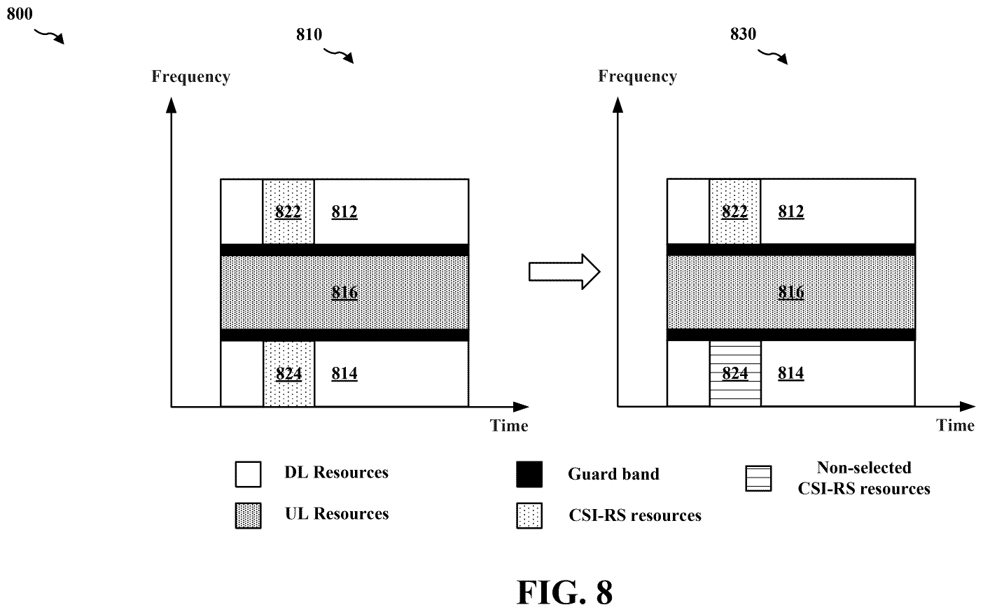

In some examples, when the SBFD-aware UEs choose to use one downlink subband (e.g., downlink subband 714) from multiple (e.g., two) downlink subbands for downlink communication, the reception and reporting of channel state information-reference signal (CSI-RS) may be implemented in various ways. In some examples, for SBFD-aware UEs indicating the capability to use the single downlink subband for downlink communication, the CSI-RS sequence mapping may apply to CSI-RS resources that are within the usable downlink PRBs of one downlink subband. FIG. 8 is a diagram 800 illustrating an example of available CSI-RS resources in accordance with various aspects of the present disclosure. In FIG. 8, the UE may receive CSI-RS resources 822 and 824 scheduled across two downlink subbands 812 and 814, respectively (as shown in 810). The two downlink subbands 812 and 814 may be separated by an uplink subband 816. As shown in 830, when the UE chooses to use one downlink subband 812 for downlink communication, the CSI-RS sequence mapping may apply to CSI-RS resource 822, which is within the usable downlink PRBs of the selected downlink subband 812, and CSI-RS resource 824, which is located outside the usable downlink PRBs, may not be used.

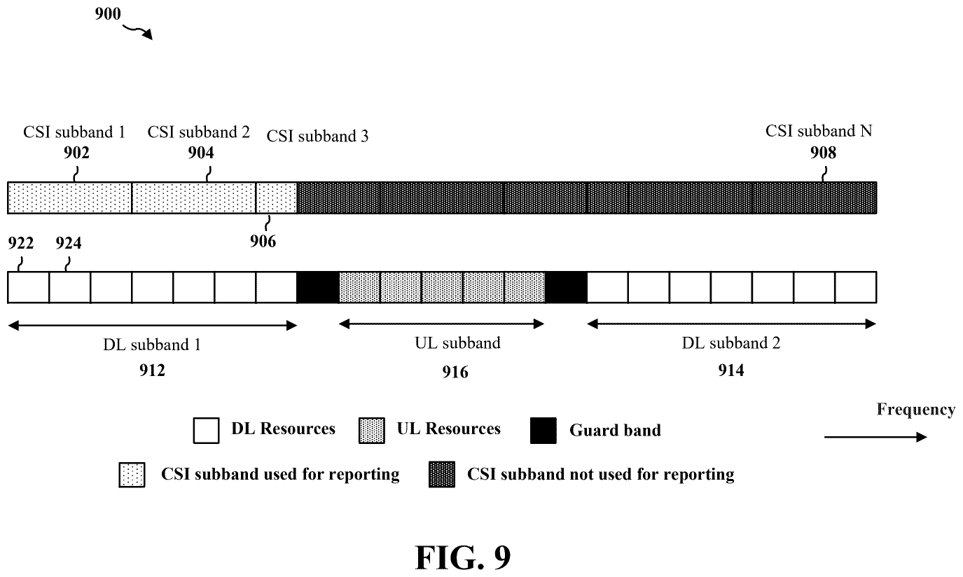

In some examples, when the SBFD-aware UEs choose to use one downlink subband (e.g., downlink subband 714) from multiple (e.g., two) downlink subbands for downlink communication, the UE may report CSI in a CSI reporting subband (or CSI subband) where there is at least one PRB within the usable downlink PRBs in the CSI reporting subband. On the other hand, any CSI reporting subband that falls outside the usable downlink PRBs may not be reported. FIG. 9 is a diagram 900 illustrating an example of CSI reporting subbands used for a CSI-RS report in accordance with various aspects of the present disclosure. In FIG. 9, a UE may report CSI on multiple CSI reporting subbands (or CSI subbands), from CSI subbands 1 902, CSI subbands 2 904, to CSI subbands N 908. When the UE chooses to use one downlink subband (e.g., downlink subband 912) for downlink communication, the UE may report CSI in CSI subband 1 902, CSI subband 2 904, and a portion 906 of CSI subband 3, which has at least one PRB, such as PRB 922, 924, within the usable downlink PRBs. On the other hand, CSI subbands that fall outside the usable downlink PRBs, including CSI subbands on uplink subband 916 and downlink subband 914 (e.g., CSI subband N 908), may not be used for CSI reporting.

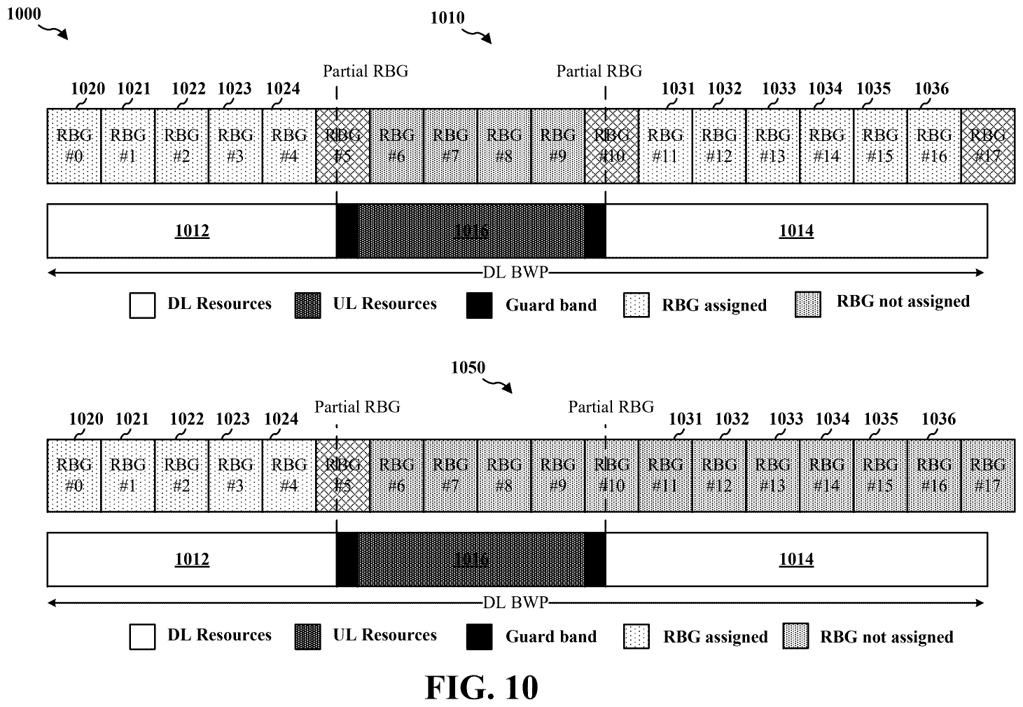

In some examples, when the SBFD-aware UEs choose to use one downlink subband (e.g., downlink subband 714) from multiple downlink subbands for downlink communication, the scheduling and transmission of the physical downlink shared channel (PDSCH) may be implemented in various ways. In some examples, for the PDSCH with a first resource allocation (RA) type (e.g., RA type 0), where the frequency domain resource allocation (FDRA) is represented as a bitmap, an SBFD-aware UE may be scheduled for PDSCH where the resource block groups (RBGs) located outside the usable downlink PRBs of the selected downlink subband are not assigned. FIG. 10 is a diagram 1000 illustrating examples of RBGs used for PDSCH scheduling in accordance with various aspects of the present disclosure. In FIG. 10, the UE may be assigned RBGs (e.g., RBGs 1020, 1021, 1022, 1023, 1024, 1031, 1032, 1033, 1034, 1035, 1036) for PDSCH across two downlink subbands 1012 and 1014, respectively (as shown in 1010). The two downlink subbands 1012 and 1014 may be separated by an uplink subband 1016. As shown in 1050, when the UE chooses to use one downlink subband 1012 for downlink communication, the UE may be assigned RBGs 1020, 1021, 1022, 1023, 1024, which are located within the usable downlink PRBs for PDSCH. The RBGs located outside the usable downlink PRBs of the selected downlink subband 1012, such as RBGs 1031, 1032, 1033, 1034, 1035, 1036, are not assigned.

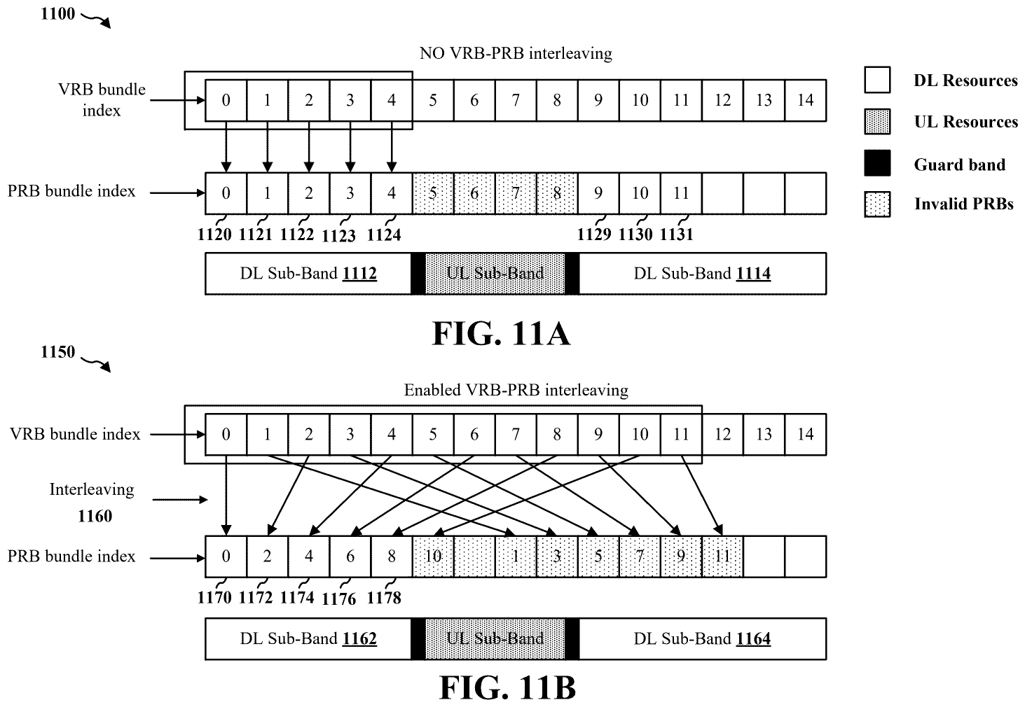

In some examples, when an SBFD-aware UE is scheduled with PDSCH with a second RA type (e.g., RA type 1) that is based on the resource indication value (RIV), and the virtual resource block (VRB) to PRB interleaving is disabled, the UE may expect the PRBs indicated by the RIV to fall within the usable downlink PRBs of the selected single downlink subband, and the UE may not expect to receive RIVs outside the usable downlink PRBs of the subband. FIG. 11A is a diagram 1100 illustrating an example of physical resource blocks (PRGs) scheduled for PDSCH in accordance with various aspects of the present disclosure. In FIG. 11A, when a UE chooses to use one downlink subband 1112 for downlink communication, the UE may expect the PRBs indicated by the RIV (e.g., PRBs 1120, 1121, 1122, 1123, 1124) to fall within the usable downlink PRBs of the selected single downlink subband 1112, and the UE may not expect to receive RIVs outside the usable downlink PRBs of the selected single subband 1112. For example, the UE may not receive PRBs 1129, 1130, 1131, which are within the downlink subband 1114 and hence are outside the usable downlink PRBs of the selected downlink subband 1112.

In some examples, when an SBFD-aware UE is scheduled with PDSCH with the second RA type (e.g., RA type 1) that is based on the RIV, and the VRB to PRB interleaving is enabled, the UE may expect that assigned PRBs within the usable PRBs of the selected downlink subband are valid for PDSCH operations, and the transport block (TB) size is determined based on these valid PRBs. Additionally, for the downlink subband that is dynamically determined (e.g., subband 764 at 754 and subband 762 at 756), the network may indicate which downlink subband to use explicitly or implicitly based on rules (e.g., the subband based on the number of resource blocks or the starting resource block). FIG. 11B is a diagram 1150 illustrating an example of PRGs scheduled for PDSCH in accordance with various aspects of the present disclosure. In FIG. 11B, an interleaving 1160 is performed between the VRBs and the PRBs. When a UE chooses to use one downlink subband 1162 (but not downlink subband 1164) for downlink communication, the UE may expect that assigned PRBs (e.g., PRBs 1170, 1172, 1174, 1176, 1178) after the interleaving 1160 within the usable PRBs of the selected downlink subband 1162 are valid for PDSCH operations, and the TB size may be determined based on these valid PRBs (e.g., PRBs 1170, 1172, 1174, 1176, 1178).

In some examples, when the SBFD-aware UEs choose to use one downlink subband (e.g., downlink subband 714) from multiple downlink subbands for downlink communication, and the UEs are monitoring PDCCH candidates in search space (SS) of a control resource set (CORESET) with non-contiguous frequency resources across multiple (e.g., two) downlink subbands in SBFD symbols or slots, the UE may determine the subband to be used for monitoring the PDCCH candidates in the SS based on the subband identification (SB-ID) that is pre-determined based on a semi-static configuration from the network. For example, in FIG. 7A, the UE may determine the subband to be used for monitoring PDCCH candidates in the SS is subband 714 based on a semi-static configuration. In some examples, for the downlink subband that is dynamically determined (e.g., subband 764 at 754 and subband 762 at 756), the UE may determine the subband to be used for monitoring the PDCCH candidates in the SS as the one containing the common search space (CSS) or synchronization signal block (SSB), or it could be chosen based on the starting resource block of the first control channel element (CCE) or resource element group (REG) in each downlink subband of the multiple downlink subband or the subband with a larger number of CCEs or REGs.

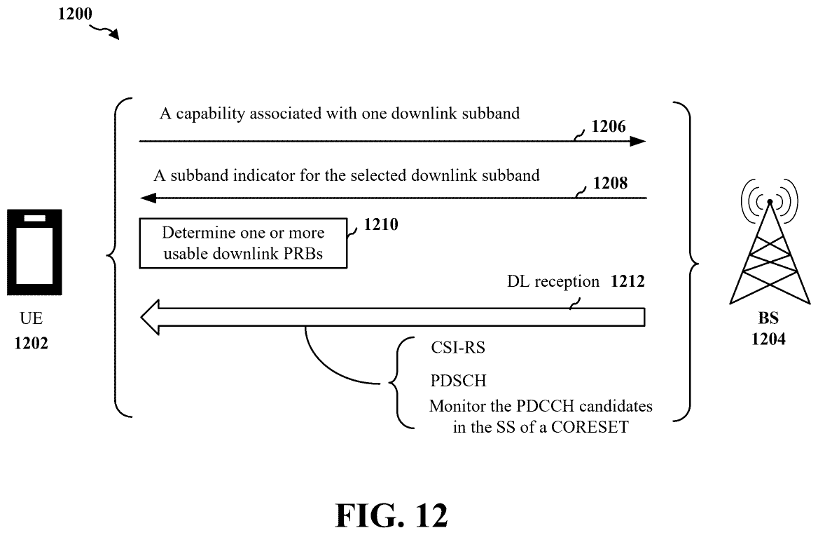

FIG. 12 is a diagram 1200 illustrating an example of wireless communication using one single downlink subband in multiple downlink subbands in accordance with various aspects of the present disclosure. In FIG. 12, the UE 1202 may be an SBFD-aware UE and may communicate simultaneously with the base station 1204 using downlink subbands (e.g., downlink subbands 712, 714) and uplink subbands (e.g., uplink subband 716).

At 1206, the UE 1202 may transmit to the base station 1204 its capability of using one single downlink subband of multiple downlink subbands for downlink communication with the base station 1204.

At 1208, the base station 1204 may send the UE 1202 a subband indicator for a selected downlink subband for downlink communication. In some examples, the base station 1204 may transmit to the UE 1202 a semi-static configuration that includes the subband indicator. In this case, the selected downlink subband may be a semi-statically fixed subband, such as downlink subband 714. In some examples, the selected downlink subband may be indicated dynamically. For example, the UE 1202 may use downlink subband 764 for downlink communication at time resources (e.g., SBFD symbols or SBFD slots) 754 and 758, and use downlink subband 762 for downlink communication at time resource (e.g., an SBFD symbol or slot) 756.

At 1210, the UE 1202 may determine one or more usable downlink physical PRBs. For example, the usable downlink PRBs may be determined based on the intersection of the downlink BWP (e.g., downlink BWP 740) and the selected downlink subband (e.g., downlink subband 714).

At 1212, the UE 1202 may use the selected single downlink and the usable downlink PRBs for downlink communication with the base station 1204. As an example, the downlink communication may include the reception of CSI-RS, PDSCH. In some examples, the UE 1202 may monitor the PDCCH candidates in the SS of a CORESET based on the selected downlink subband and usable downlink PRBs. For example, if the selected downlink subband is a semi-statically fixed subband (e.g., downlink subband 714), the UE 1202 may monitor the PDCCH candidates in the SS of a CORESET on the selected downlink subband. If the downlink subband is dynamically selected, the UE 1202 may monitor the PDCCH candidates in the SS of a CORESET on one downlink subband that can be determined based on CSS or SSB in the downlink subband, the start RB of the first CCE or REG in the downlink subband, or the number of CCEs or REGs in the downlink subband.

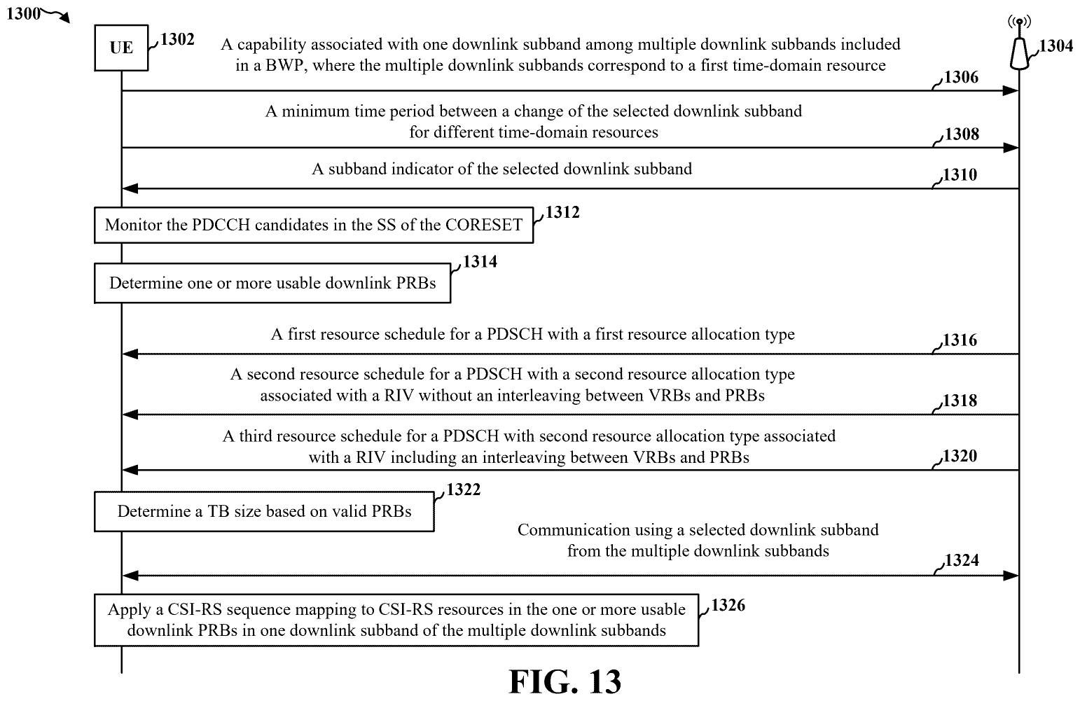

FIG. 13 is a call flow diagram 1300 illustrating a method of wireless communication in accordance with various aspects of this present disclosure. Various aspects are described in connection with a UE 1302 and a base station 1304. The aspects may be performed by the UE 1302 or the base station 1304 in aggregation and/or by one or more components of a base station 1304 (e.g., a CU 110, a DU 130, and/or an RU 140).

As shown in FIG. 13, at 1306, the UE 1302 may transmit to base station 1304 a capability associated with one downlink subband among multiple downlink subbands included in a downlink BWP. The multiple downlink subbands may correspond to a first time-domain resource. For example, the first time-domain resource may include an SBFD symbol or an SBFD slot. For example, referring to FIG. 7A, the multiple downlink subbands may include downlink subbands 712, 714, which may correspond to the first time-domain resource 704. The one downlink subband may be downlink subband 712.

At 1308, the UE 1302 may transmit a minimum time period between a change of the selected downlink subband for different time-domain resources to base station 1304. For example, referring to FIG. 7B, the minimum time period may be the time period for UE 1302 to change from using downlink subband 764 to using downlink subband 762 for downlink communication.

At 1310, the UE 1302 may receive a subband indicator of the selected downlink subband. In some examples, the UE 1302 may receive from base station 1304 a semi-static configuration that includes the subband indicator. In this case, the selected downlink subband may be a semi-statically fixed subband, such as downlink subband 714. In some examples, the selected downlink subband may be indicated dynamically. For example, the UE 1302 may use downlink subband 764 for downlink communication at time resources (e.g., SBFD symbols or SBFD slots) 754 and 758, and use downlink subband 762 for downlink communication at time resource (e.g., an SBFD symbol or slot) 756.

At 1312, the UE 1302 may monitor the PDCCH candidates in an SS of a CORESET associated with a PDCCH on the selected downlink subband (e.g., downlink subband 714). In some examples, the CORESET may span multiple downlink subbands (e.g., downlink subband 712, 714).

At 1314, the UE 1302 may determine one or more usable downlink PRBs based on an intersection of the downlink BWP and the selected downlink subband. For example, the usable downlink PRBs may be determined based on the intersection of the downlink BWP (e.g., downlink BWP 740) and the selected downlink subband (e.g., downlink subband 714).

At 1316, the UE 1302 may receive from base station 1304 a first resource schedule for a PDSCH with a first resource allocation type associated with a bitmap for FDRA. The first resource schedule for the PDSCH may not include any RBG outside the one or more usable downlink PRBs.

At 1318, the UE 1302 may receive from base station 1304 a second resource schedule for a PDSCH with a second resource allocation type associated with an RIV without an interleaving between VRBs and PRBs. The second resource schedule may not include any PRB outside the one or more usable downlink PRBs.

At 1320, the UE 1302 may receive a third resource schedule for a PDSCH with a second resource allocation type associated with an RIV including an interleaving between VRBs and PRBs.

At 1322, the UE 1302 may determine a TB size based on valid PRBs. The valid PRBs may include the PRBs assigned by the third resource schedule within one usable downlink PRB of the one or more usable downlink PRBs after the interleaving.

At 1324, the UE 1302 may communicate with base station 1304 using the selected downlink subband (e.g., downlink subband 714) from the multiple downlink subbands (e.g., downlink subbands 712 and 714) for one or more time-domain resources (e.g., 704, 706, 708). The one or more time-domain resources (e.g., 704, 706, 708) may include the first time-domain resource (e.g., at 1306). The downlink BWP may include the multiple downlink subbands (e.g., downlink subbands 712 and 714).

At 1326, the UE 1302 may apply a CSI-RS sequence mapping to CSI-RS resources in the one or more usable downlink PRBs in one downlink subband (e.g., downlink subband 714) of the multiple downlink subbands.

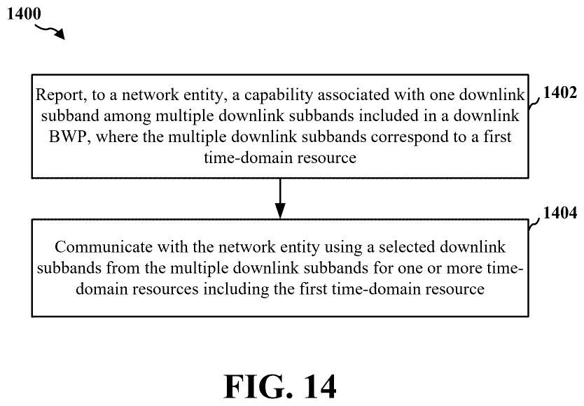

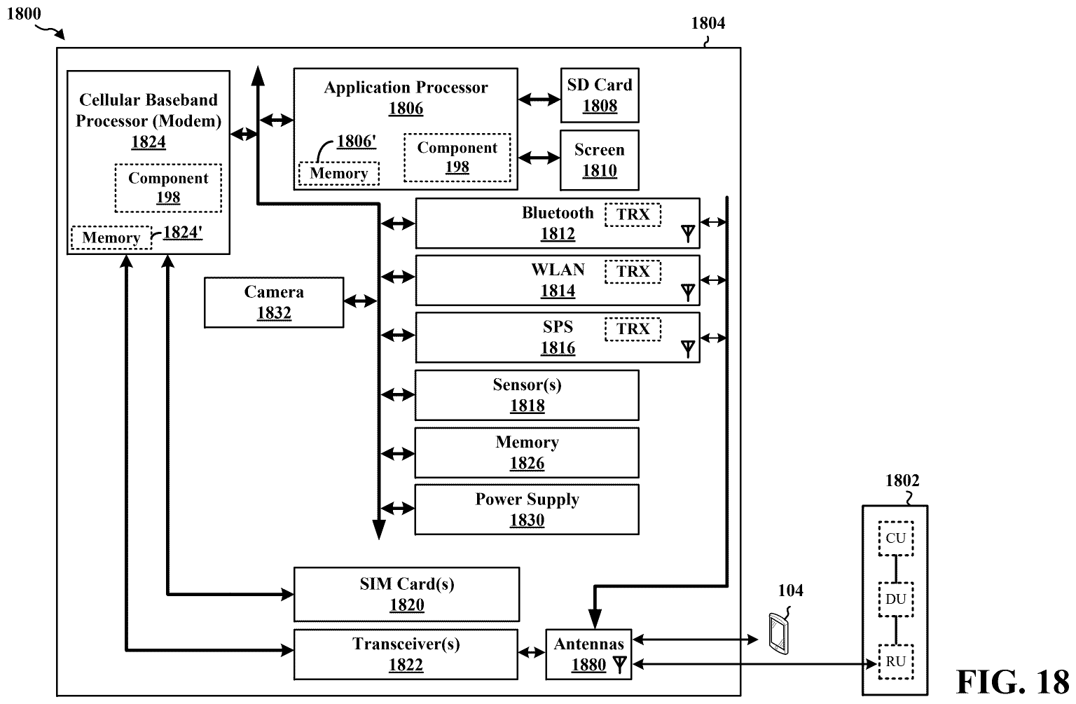

FIG. 14 is a flowchart 1400 illustrating methods of wireless communication at a UE in accordance with various aspects of the present disclosure. The method may be performed by a UE in coorperation with a network entity. The UE may be the UE 104, 350, 1202, 1302, or the apparatus 1804 in the hardware implementation of FIG. 18. The network entity may be a base station, or a component of a base station, in the access network of FIG. 1 or a core network component (e.g., base station 102, 310, 1204, 1304; or the network entity 1802 in the hardware implementation of FIG. 18). By enabling the use of a single downlink subband for an SBFD-aware UE where multiple downlink subbands are available, the methods ensure broader compatibility across various device types within the network, including UEs with limited processing power or spectrum capability. Additionally, by providing both semi-static and dynamic scheduling options for selecting the single downlink subband, the methods allow flexible adjustment of the single downlink subband based on network conditions and UE capabilities, thereby improving the overall network efficiency and performance. In some examples, by allowing a simpler downlink filtering process on a single downlink subband, compared to using notch filters across multiple subbands, the methods reduce the computational load on the UE.

As shown in FIG. 14, at 1402, the UE may report, to the network entity, a capability associated with one downlink subband among multiple downlink subbands included in a downlink BWP. The multiple downlink subbands may correspond to a first time-domain resource. FIG. 7A, FIG. 7B, FIG. 8, FIG. 9, FIG. 10, FIG. 11A, FIG. 11B, FIG. 12, and FIG. 13 illustrate various aspects in connection with flowchart 1400. For example, referring to FIG. 7A and FIG. 13, the UE 1302 may, at 1306, report to the network entity (base station 1304) a capability associated with one downlink subband (e.g., downlink subband 712) among multiple downlink subbands (e.g., downlink subbands 712, 714) included in a downlink BWP (e.g., downlink BWP 740). The multiple downlink subbands (e.g., downlink subbands 712, 714) may correspond to a first time-domain resource (e.g., 704). In some examples, 1402 may be performed by the downlink subband component 198.

At 1404, the UE may communicate with the network entity using a selected downlink subband from the multiple downlink subbands for one or more time-domain resources including the first time-domain resource. For example, referring to FIG. 13, the UE 1302 may, at 1324, communicate with the network entity (base station 1304) using a selected downlink subband from the multiple downlink subbands for one or more time-domain resources including the first time-domain resource. Referring to FIG. 7A, the UE may use downlink subband 714 from multiple downlink subbands (e.g., downlink subbands 712, 714) to communicate with the network entity for time-domain resources 704, 706, 708 including the first time-domain resources (e.g., 704). In some examples, 1404 may be performed by the downlink subband component 198.

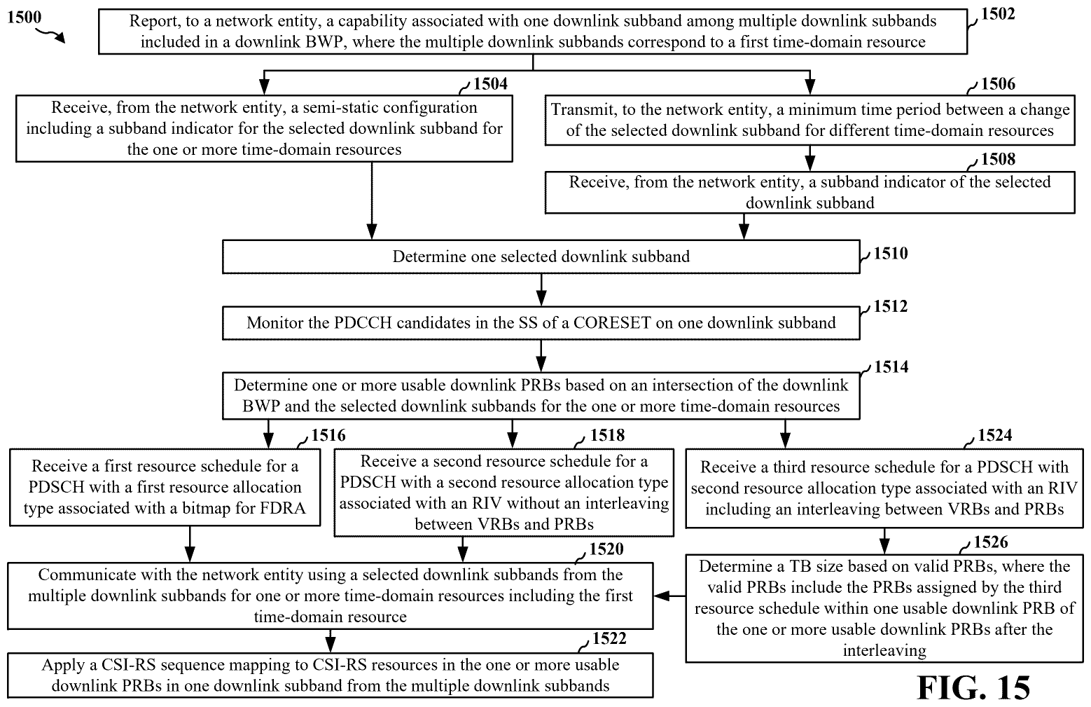

FIG. 15 is a flowchart 1500 illustrating methods of wireless communication at a UE in accordance with various aspects of the present disclosure. The method may be performed by a UE in coorpesration with a network entity. The UE may be the UE 104, 350, 1202, 1302, or the apparatus 1804 in the hardware implementation of FIG. 18. The network entity may be a base station, or a component of a base station, in the access network of FIG. 1 or a core network component (e.g., base station 102, 310, 1204, 1304; or the network entity 1802 in the hardware implementation of FIG. 18). By enabling the use of a single downlink subband for an SBFD-aware UE where multiple downlink subbands are available, the methods ensure broader compatibility across various device types within the network, including UEs with limited processing power or spectrum capability. Additionally, by providing both semi-static and dynamic scheduling options for selecting the single downlink subband, the methods allow flexible adjustment of the single downlink subband based on network conditions and UE capabilities, thereby improving the overall network efficiency and performance. In some examples, by allowing a simpler downlink filtering process on a single downlink subband, compared to using notch filters across multiple subbands, the methods reduce the computational load on the UE.

As shown in FIG. 15, at 1502, the UE may report, to the network entity, a capability associated with one downlink subband among multiple downlink subbands included in a downlink BWP. The multiple downlink subbands may correspond to a first time-domain resource. FIG. 7A, FIG. 7B, FIG. 8, FIG. 9, FIG. 10, FIG. 11A, FIG. 11B, FIG. 12, and FIG. 13 illustrate various aspects in connection with flowchart 1500. For example, referring to FIG. 7A and FIG. 13, the UE 1302 may, at 1306, report to the network entity (base station 1304) a capability associated with one downlink subband (e.g., downlink subband 712) among multiple downlink subbands (e.g., downlink subbands 712, 714) included in a downlink BWP (e.g., downlink BWP 740). The multiple downlink subbands (e.g., downlink subbands 712, 714) may correspond to a first time-domain resource (e.g., 704). In some examples, 1502 may be performed by the downlink subband component 198.

At 1520, the UE may communicate with the network entity using a selected downlink subband from the multiple downlink subbands for one or more time-domain resources including the first time-domain resource. For example, referring to FIG. 13, the UE 1302 may, at 1324, communicate with the network entity (base station 1304) using a selected downlink subband from the multiple downlink subbands for one or more time-domain resources including the first time-domain resource. Referring to FIG. 7A, the UE may use downlink subband 714 from multiple downlink subbands (e.g., downlink subbands 712, 714) to communicate with the network entity for time-domain resources 704, 706, 708 including the first time-domain resource (e.g., 704). In some examples, 1520 may be performed by the downlink subband component 198.

In some aspects, the first time-domain resource may include an SBFD symbol or an SBFD slot. For example, referring to FIG. 7A, the first time-domain resource (e.g., 704) may include an SBFD symbol or an SBFD slot.

In some aspects, the multiple downlink subbands may include two downlink subbands separated by an uplink subband, and an unselected downlink subband of the two downlink subbands may not be used for communication with the network entity. For example, referring to FIG. 7A, the multiple downlink subbands may include two downlink subbands 712 and 714 separated by an uplink subband 716, and an unselected downlink subband 712 of the two downlink subbands may not be used for communication with the network entity.

In some aspects, the UE may receive, from the network entity, a data or control signal using the selected downlink subband, and the UE may be in an RRC connected state. In some examples, the UE may perform SDT with the network entity using the selected downlink subband, and the UE may be in an RRC idle state or an RRC inactive state. For example, referring to FIG. 13, at 1324, the communication with the base station 1304 may include the UE 1302 receiving a data or control signal using the selected downlink subband, and the UE 1302 may be in an RRC connected state. In some examples, the communication with the base station 1304 (at 1324) may include the UE 1302 performing SDT with the base station 1304 using the selected downlink subband, and the UE 1302 may be in an RRC idle state or an RRC inactive state. As used herein, the term “data or control signal” may refer to a signal that carries control information for communication between the UE and the network, a signal that carries user data, or a signal that carries scheduling information, among other examples.

In some aspects, at 1514, the UE may determine one or more usable downlink PRBs based on an intersection of the downlink BWP and the selected downlink subband for the one or more time-domain resources. For example, referring to FIG. 13, the UE 1302 may, at 1314, determine one or more usable downlink PRBs. Referring to FIG. 7A, the one or more usable downlink PRBs may be determined based on an intersection of the downlink BWP 740 and the selected downlink subband 714. In some examples, 1514 may be performed by the downlink subband component 198.

In some aspects, to communicate with the network entity using the selected downlink subband (at 1520), the UE may receive a CSI-RS using the selected downlink subband. At 1522, the UE may apply a CSI-RS sequence mapping to CSI-RS resources in the one or more usable downlink PRBs in the selected downlink subband from the multiple downlink subbands. For example, referring to FIG. 8, the UE may receive a CSI-RS using the selected downlink subband 812, and the UE may apply a CSI-RS sequence mapping to CSI-RS resources 822 in the one or more usable downlink PRBs in one downlink subband 812 from the multiple downlink subbands (e.g., downlink subbands 812 and 814). In some examples, 1522 may be performed by the downlink subband component 198.

In some aspects, to communicate with the network entity using the selected downlink subband (at 1520), the UE may transmit, to the network entity, a CSI-RS report. The CSI reporting subband for the CSI-RS report may include at least one usable downlink PRB of the one or more usable downlink PRBs, and any CSI reporting subband outside the one or more usable downlink PRBs may not be reported in the CSI-RS report. For example, referring to FIG. 9, the CSI reporting subband (e.g., CSI subband 1 902, CSI subband 2 904) for the CSI-RS report may include at least one usable downlink PRB of the one or more usable downlink PRBs (e.g., PRBs 922, 924 in downlink subband 1 912), and any CSI reporting subband outside the one or more usable downlink PRBs (e.g., CSI subband N 908) may not be reported in the CSI-RS report.

In some aspects, at 1516, the UE may receive a first resource schedule for a PDSCH with a first resource allocation type associated with a bitmap for FDRA. The first resource schedule for the PDSCH may not include any RBG outside the one or more usable downlink PRBs. For example, referring to FIG. 10, at 1050, when the UE chooses to use downlink subband 1012 (but not downlink subband 1014) for downlink communication, the RBG outside the one or more usable downlink PRBs, such as RBG 1031, 1032, 1033, 1034, may not be assigned to the UE for receiving a PDSCH. In some examples, 1516 may be performed by the downlink subband component 198.

In some aspects, at 1518, the UE may receive a second resource schedule for a PDSCH with a second resource allocation type associated with an RIV without an interleaving between VRBs and PRBs. The second resource schedule may not include any PRB outside the one or more usable downlink PRBs. For example, referring to FIG. 11A, when the UE chooses to use downlink subband 1112 (but not downlink subband 1114) for downlink communication, the resource schedule may not include PRBs 1129, 1130, 1131, which are outside the one or more usable downlink PRBs. In some examples, 1518 may be performed by the downlink subband component 198.

In some aspects, at 1524, the UE may receive a third resource schedule for a PDSCH with a second resource allocation type associated with an RIV including an interleaving between VRBs and PRBs. At 1526, the UE may determine the TB size based on valid PRBs. The valid PRBs may include the PRBs assigned by the third resource schedule within one usable downlink PRB of the one or more usable downlink PRBs after the interleaving. For example, referring to FIG. 11B, the valid PRBs may include the PRBs 1170, 1172, 1174, 1176, 1178, which are within one usable downlink PRB of the one or more usable downlink PRBs after the interleaving 1160. In some examples, 1524 and 1526 may be performed by the downlink subband component 198.

In some aspects, the capability may be a semi-static subband capability, and the selected downlink subband for the one or more time-domain resources may be the same downlink subband. For example, referring to FIG. 13, the capability (at 1306) may be a semi-static subband capability. Referring to FIG. 7A, the selected downlink subband 714 may be the same for the one or more time-domain resources 704, 706, 708.

In some aspects, at 1504, the UE may receive, from the network entity, a semi-static configuration including a subband indicator for the selected downlink subband for the one or more time-domain resources. At 1510, the UE may determine the selected downlink subband based on the subband indicator. For example, referring to FIG. 13, the UE 1302 may, at 1310, receive from the network entity (base station 1304) a semi-static configuration including a subband indicator for the selected downlink subband for the one or more time-domain resources. The UE 1302 may determine the selected downlink subband based on the subband indicator received at 1310. In some examples, 1504 and 1510 may be performed by the downlink subband component 198.

In some aspects, at 1512, the UE may monitor the PDCCH candidates in the SS of a CORESET associated with a PDCCH on the selected downlink subband. The CORESET may span the multiple downlink subbands. For example, referring to FIG. 7A and FIG. 13, the UE 1302 may, at 1312, monitor the PDCCH candidates in the SS of a CORESET associated with a PDCCH on the selected downlink subband (e.g., downlink subband 714). The CORESET may span the multiple downlink subbands (e.g., downlink subband 712, 714). In some examples, 1512 may be performed by the downlink subband component 198.

In some aspects, the capability may be a dynamic subband capability, and the selected downlink subband for the one or more time-domain resources may be different downlink subbands. For example, referring to FIG. 7B, the selected downlink subband may be downlink subband 764 for time-domain resources 754 and 758, and downlink subband 762 for time-domain resource 756.

In some aspects, at 1506, the UE may transmit, to the network entity, a minimum time period between the change of the selected downlink subband for different time-domain resources. For example, referring to FIG. 13, the UE 1302 may, at 1308, transmit to the network entity (base station 1304) a minimum time period between the change of the selected downlink subband for different time-domain resources. Referring to FIG. 7B, the minimum time period may be the time period for UE to change from using downlink subband 764 to using downlink subband 762 for downlink communication. In some examples, 1506 may be performed by the downlink subband component 198.

In some aspects, at 1508, the UE may receive, from the network entity, a subband indicator of the selected downlink subband. The subband indicator may be based on one of: a DCI indication for the selected downlink subband, or a start RB for a downlink signal or channel. For example, referring to FIG. 13, the UE 1302 may, at 1310, receive from the network entity (base station 1304) a subband indicator of the selected downlink subband. The subband indicator may be based on one of: a DCI indication for the selected downlink subband, or a start RB for a downlink signal or channel. In some examples, 1508 and 1510 may be performed by the downlink subband component 198.

In some aspects, at 1510, the UE may determine the selected downlink subband from the multiple downlink subbands for monitoring the PDCCH candidates in the SS of a CORESET associated with a PDCCH. At 1512, the UE may monitor the PDCCH candidates in the SS of the CORESET using the one downlink subband, and the one downlink subband may be determined based on one or more of: CSS or SSB in each downlink subband of the multiple downlink subbands, a start RB of a first CCE or REG in each downlink subband of the multiple downlink subbands, or the number of CCEs or REGs in each downlink subband of the multiple downlink subbands. For example, referring to FIG. 13, the UE 1302 may determine the selected downlink subband from the multiple downlink subbands (e.g., based on the subband indicator received at 1310) for monitoring the PDCCH candidates in the SS of a CORESET associated with a PDCCH. At 1312, the UE 1302 may monitor the PDCCH candidates in the SS of the CORESET using the selected downlink subband, and the selected downlink subband may be determined based on one or more of: CSS or SSB in each downlink subband of the multiple downlink subbands, a start RB of a first CCE or REG in each downlink subband of the multiple downlink subbands, or the number of CCEs or REGs in each downlink subband of the multiple downlink subbands.

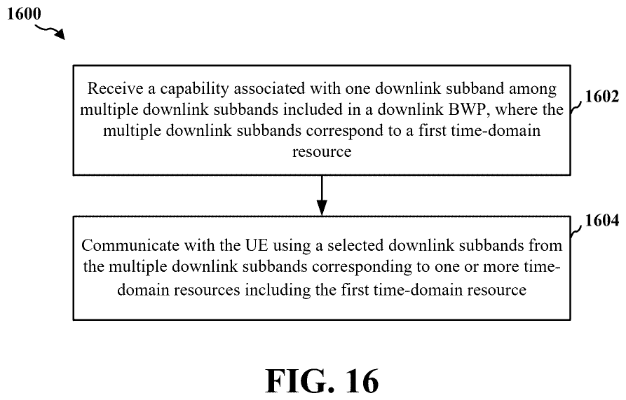

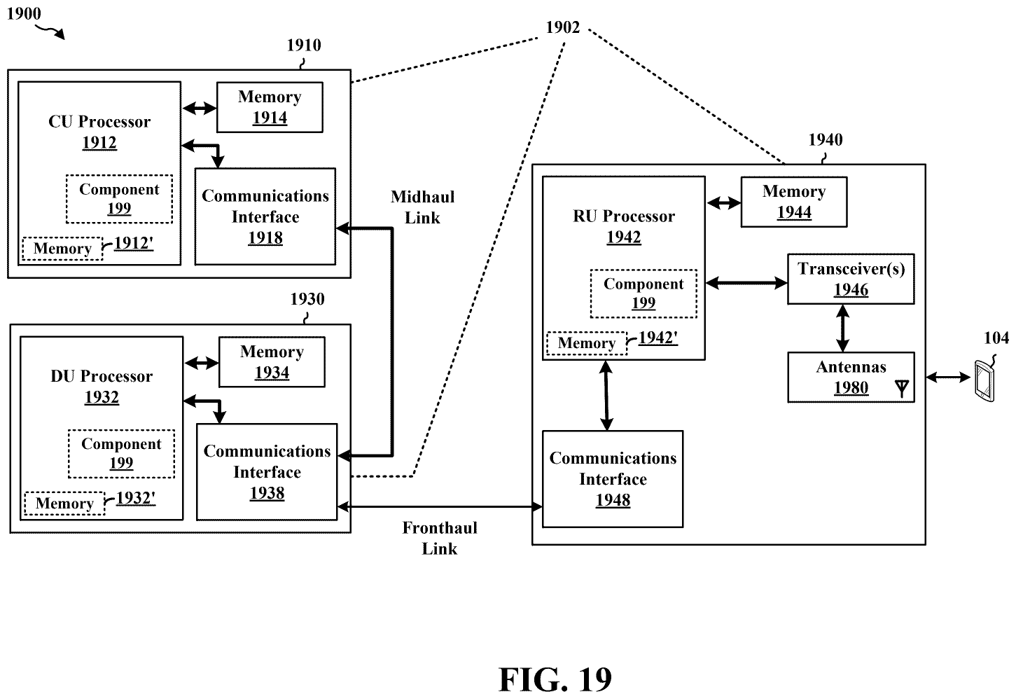

FIG. 16 is a flowchart 1600 illustrating methods of wireless communication at a network entity in accordance with various aspects of the present disclosure. The method may be performed by a network entity in cooperation with a UE. The network entity may be a base station, or a component of a base station, in the access network of FIG. 1 or a core network component (e.g., base station 102, 310, 1204, 1304; or the network entity 1902 in the hardware implementation of FIG. 19). The UE may be the UE 104, 350, 1202, 1302, or the apparatus 1804 in the hardware implementation of FIG. 18. By enabling the use of a single downlink subband for an SBFD-aware UE where multiple downlink subbands are available, the methods ensure broader compatibility across various device types within the network, including UEs with limited processing power or spectrum capability. Additionally, by providing both semi-static and dynamic scheduling options for selecting the single downlink subband, the methods allow flexible adjustment of the single downlink subband based on network conditions and UE capabilities, thereby improving the overall network efficiency and performance. In some examples, by allowing a simpler downlink filtering process on a single downlink subband, compared to using notch filters across multiple subbands, the methods reduce the computational load on the UE.

As shown in FIG. 16, at 1602, the network entity may receive a capability associated with one downlink subband among multiple downlink subbands included in a downlink BWP. The multiple downlink subbands may correspond to a first time-domain resource. FIG. 7A, FIG. 7B, FIG. 8, FIG. 9, FIG. 10, FIG. 11A, FIG. 11B, FIG. 12, and FIG. 13 illustrate various aspects in connection with flowchart 1600. For example, referring to FIG. 7A and FIG. 13, the network entity (base station 1304) may, at 1306, receive from UE 1302 a capability associated with one downlink subband (e.g., downlink subband 712) among multiple downlink subbands (e.g., downlink subbands 712, 714) included in a downlink BWP (e.g., downlink BWP 740). The multiple downlink subbands (e.g., downlink subbands 712, 714) may correspond to a first time-domain resource (e.g., 704). In some aspects, 1602 may be performed by the downlink subband component 199.

At 1604, the network entity may communicate with the UE using a selected downlink subband from the multiple downlink subbands corresponding to one or more time-domain resources including the first time-domain resource. For example, referring to FIG. 7A and FIG. 13, the network entity (base station 1304) may, at 1324, communicate with the UE 1302 using a selected downlink subband (e.g., downlink subband 714) from the multiple downlink subbands (e.g., downlink subbands 712, 714) corresponding to one or more time-domain resources (e.g., 704, 706, 708) including the first time-domain resource (e.g., 704). In some aspects, 1604 may be performed by the downlink subband component 199.

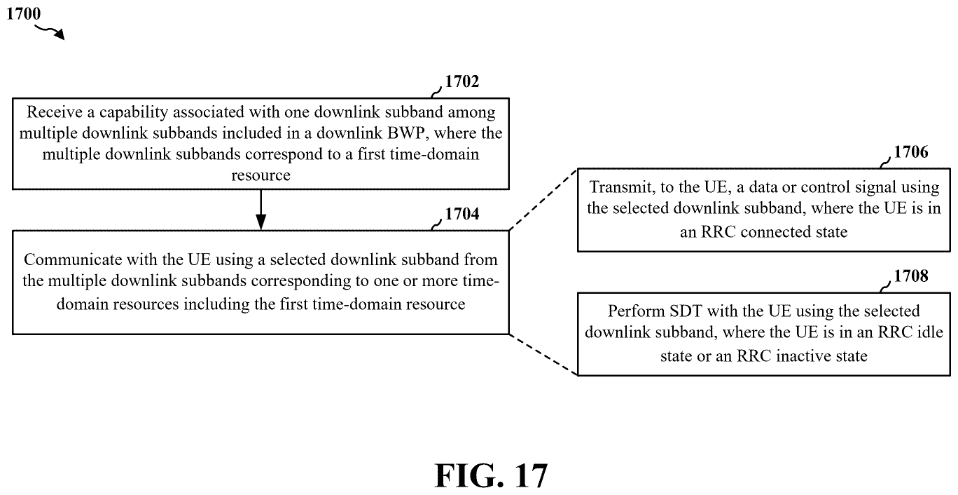

FIG. 17 is a flowchart 1700 illustrating methods of wireless communication at a network entity in accordance with various aspects of the present disclosure. The method may be performed by a network entity in cooperation with a UE. The network entity may be a base station, or a component of a base station, in the access network of FIG. 1 or a core network component (e.g., base station 102, 310, 1204, 1304; or the network entity 1902 in the hardware implementation of FIG. 19). The UE may be the UE 104, 350, 1202, 1302, or the apparatus 1804 in the hardware implementation of FIG. 18. By enabling the use of a single downlink subband for an SBFD-aware UE where multiple downlink subbands are available, the methods ensure broader compatibility across various device types within the network, including UEs with limited processing power or spectrum capability. Additionally, by providing both semi-static and dynamic scheduling options for selecting the single downlink subband, the methods allow flexible adjustment of the single downlink subband based on network conditions and UE capabilities, thereby improving the overall network efficiency and performance. In some examples, by allowing a simpler downlink filtering process on a single downlink subband, compared to using notch filters across multiple subbands, the methods reduce the computational load on the UE.

As shown in FIG. 17, at 1702, the network entity may receive a capability associated with one downlink subband among multiple downlink subbands included in a downlink BWP. The multiple downlink subbands may correspond to a first time-domain resource. FIG. 7A, FIG. 7B, FIG. 8, FIG. 9, FIG. 10, FIG. 11A, FIG. 11B, FIG. 12, and FIG. 13 illustrate various aspects in connection with flowchart 1700. For example, referring to FIG. 7A and FIG. 13, the network entity (base station 1304) may, at 1306, receive from UE 1302 a capability associated with one downlink subband (e.g., downlink subband 712) among multiple downlink subbands (e.g., downlink subbands 712, 714) included in a downlink BWP (e.g., downlink BWP 740). The multiple downlink subbands (e.g., downlink subbands 712, 714) may correspond to a first time-domain resource (e.g., 704). In some aspects, 1702 may be performed by the downlink subband component 199.

At 1704, the network entity may communicate with the UE using a selected downlink subband from the multiple downlink subbands corresponding to one or more time-domain resources including the first time-domain resource. For example, referring to FIG. 7A and FIG. 13, the network entity (base station 1304) may, at 1324, communicate with the UE 1302 using a selected downlink subband (e.g., downlink subband 714) from the multiple downlink subbands (e.g., downlink subbands 712, 714) corresponding to one or more time-domain resources (e.g., 704, 706, 708) including the first time-domain resource (e.g., 704). In some aspects, 1704 may be performed by the downlink subband component 199.

In some aspects, the first time-domain resource may include an SBFD symbol or an SBFD slot. For example, referring to FIG. 7A, the first time-domain resource (e.g., 704) may include an SBFD symbol or an SBFD slot.

In some aspects, the multiple downlink subbands may include two downlink subbands separated by an uplink subband, and an unselected downlink subband of the two downlink subbands may not be used for communication with the UE. For example, referring to FIG. 7A, the multiple downlink subbands may include two downlink subbands 712 and 714 separated by an uplink subband 716, and an unselected downlink subband 712 of the two downlink subbands may not be used for communication with the network entity.

In some aspects, to communicate with the UE using the selected downlink subband (at 1704), the network entity may, at 1706, transmit, to the UE, a data or control signal using the selected downlink subband, where the UE is in an RRC connected state, or, at 1708, perform SDT with the UE using the selected downlink subband, where the UE is in an RRC idle state or an RRC inactive state. For example, referring to FIG. 13, at 1324, the communication with the UE 1302 may include the base station 1304 transmitting a data or control signal to UE 1302 using the selected downlink subband, and the UE 1302 may be in an RRC connected state. In some examples, the communication with the UE 1302 (at 1324) may include the base station 1304 performing SDT with the UE 1302 using the selected downlink subband, and the UE 1302 may be in an RRC idle state or an RRC inactive state. In some aspects, 1706 and 1708 may be performed by the downlink subband component 199.

FIG. 18 is a diagram 1800 illustrating an example of a hardware implementation for an apparatus 1804. The apparatus 1804 may be a UE, a component of a UE, or may implement UE functionality. In some aspects, the apparatus 1804 may include at least one cellular baseband processor (or processing circuitry) 1824 (also referred to as a modem) coupled to one or more transceivers 1822 (e.g., cellular RF transceiver). The cellular baseband processor(s) (or processing circuitry) 1824 may include at least one on-chip memory (or memory circuitry) 1824′. In some aspects, the apparatus 1804 may further include one or more subscriber identity modules (SIM) cards 1820 and at least one application processor (or processing circuitry) 1806 coupled to a secure digital (SD) card 1808 and a screen 1810. The application processor(s) (or processing circuitry) 1806 may include on-chip memory (or memory circuitry) 1806′. In some aspects, the apparatus 1804 may further include a Bluetooth module 1812, a WLAN module 1814, an SPS module 1816 (e.g., GNSS module), one or more sensor modules 1818 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1826, a power supply 1830, and/or a camera 1832. The Bluetooth module 1812, the WLAN module 1814, and the SPS module 1816 may include an on-chip transceiver (TRX) (or in some cases, just a receiver (RX)). The Bluetooth module 1812, the WLAN module 1814, and the SPS module 1816 may include their own dedicated antennas and/or utilize the antennas 1880 for communication. The cellular baseband processor(s) (or processing circuitry) 1824 communicates through the transceiver(s) 1822 via one or more antennas 1880 with the UE 104 and/or with an RU associated with a network entity 1802. The cellular baseband processor(s) (or processing circuitry) 1824 and the application processor(s) (or processing circuitry) 1806 may each include a computer-readable medium/memory (or memory circuitry) 1824′, 1806′, respectively. The additional memory modules 1826 may also be considered a computer-readable medium/memory (or memory circuitry). Each computer-readable medium/memory (or memory circuitry) 1824′, 1806′, 1826 may be non-transitory. The cellular baseband processor(s) (or processing circuitry) 1824 and the application processor(s) (or processing circuitry) 1806 are each responsible for general processing, including the execution of software stored on the computer-readable medium/memory (or memory circuitry). The software, when executed by the cellular baseband processor(s) (or processing circuitry) 1824/application processor(s) (or processing circuitry) 1806, causes the cellular baseband processor(s) (or processing circuitry) 1824/application processor(s) (or processing circuitry) 1806 to perform the various functions described supra. The cellular baseband processor(s) (or processing circuitry) 1824 and the application processor(s) (or processing circuitry) 1806 are configured to perform the various functions described supra based at least in part of the information stored in the memory (or memory circuitry). That is, the cellular baseband processor(s) (or processing circuitry) 1824 and the application processor(s) (or processing circuitry) 1806 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1824/application processor(s) (or processing circuitry) 1806 when executing software. The cellular baseband processor(s) (or processing circuitry) 1824/application processor(s) (or processing circuitry) 1806 may be a component of the UE 350 and may include the at least one memory 360 and/or at least one of the TX processor 368, the RX processor 356, and the controller/processor 359. In one configuration, the apparatus 1804 may be at least one processor chip (modem and/or application) and include just the cellular baseband processor(s) (or processing circuitry) 1824 and/or the application processor(s) (or processing circuitry) 1806, and in another configuration, the apparatus 1804 may be the entire UE (e.g., see UE 350 of FIG. 3) and include the additional modules of the apparatus 1804.

As discussed supra, the component 198 may be configured to report, to a network entity, a capability associated with one downlink subband among multiple downlink subbands included in a downlink BWP, where the multiple downlink subbands correspond to a time-domain resource; and communicate with the network entity using a selected downlink subband for one or more time-domain resources including the first time-domain resource. The component 198 may be further configured to perform any of the aspects described in connection with the flowcharts in FIG. 14 and FIG. 15, and/or performed by the UE 1302 in FIG. 13. The component 198 may be within the cellular baseband processor(s) (or processing circuitry) 1824, the application processor(s) (or processing circuitry) 1806, or both the cellular baseband processor(s) (or processing circuitry) 1824 and the application processor(s) (or processing circuitry) 1806. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1804 may include a variety of components configured for various functions. In one configuration, the apparatus 1804, and in particular the cellular baseband processor(s) (or processing circuitry) 1824 and/or the application processor(s) (or processing circuitry) 1806, includes means for reporting, to a network entity, a capability associated with one downlink subband among multiple downlink subbands included in a downlink BWP, where the multiple downlink subbands correspond to a time-domain resource, and means for communicating with the network entity using a selected downlink subband for one or more time-domain resources including the first time-domain resource. The apparatus 1804 may further include means for performing any of the aspects described in connection with the flowcharts in FIG. 14 and FIG. 15, and/or aspects performed by the UE 1302 in FIG. 13. The means may be the component 198 of the apparatus 1804 configured to perform the functions recited by the means. As described supra, the apparatus 1804 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 19 is a diagram 1900 illustrating an example of a hardware implementation for a network entity 1902. The network entity 1902 may be a BS, a component of a BS, or may implement BS functionality. The network entity 1902 may include at least one of a CU 1910, a DU 1930, or an RU 1940. For example, depending on the layer functionality handled by the component 199, the network entity 1902 may include the CU 1910; both the CU 1910 and the DU 1930; each of the CU 1910, the DU 1930, and the RU 1940; the DU 1930; both the DU 1930 and the RU 1940; or the RU 1940. The CU 1910 may include at least one CU processor (or processing circuitry) 1912. The CU processor(s) (or processing circuitry) 1912 may include on-chip memory (or memory circuitry) 1912′. In some aspects, the CU 1910 may further include additional memory modules 1914 and a communications interface 1918. The CU 1910 communicates with the DU 1930 through a midhaul link, such as an F1 interface. The DU 1930 may include at least one DU processor (or processing circuitry) 1932. The DU processor(s) (or processing circuitry) 1932 may include on-chip memory (or memory circuitry) 1932′. In some aspects, the DU 1930 may further include additional memory modules 1934 and a communications interface 1938. The DU 1930 communicates with the RU 1940 through a fronthaul link. The RU 1940 may include at least one RU processor (or processing circuitry) 1942. The RU processor(s) (or processing circuitry) 1942 may include on-chip memory (or memory circuitry) 1942′. In some aspects, the RU 1940 may further include additional memory modules 1944, one or more transceivers 1946, antennas 1980, and a communications interface 1948. The RU 1940 communicates with the UE 104. The on-chip memory (or memory circuitry) 1912′, 1932′, 1942′ and the additional memory modules 1914, 1934, 1944 may each be considered a computer-readable medium/memory (or memory circuitry). Each computer-readable medium/memory (or memory circuitry) may be non-transitory. Each of the processors (or processing circuitry) 1912, 1932, 1942 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to receive a capability associated with one downlink subband among multiple downlink subbands included in a downlink BWP, where the multiple downlink subbands correspond to a time-domain resource; and communicate with the UE using a selected downlink subband from the multiple downlink subbands corresponding to one or more time-domain resources including the first time-domain resource. The downlink BWP may include the multiple downlink subbands. The component 199 may be further configured to perform any of the aspects described in connection with the flowcharts in FIG. 16 and FIG. 17, and/or performed by the base station 1304 in FIG. 13. The component 199 may be within one or more processors (or processing circuitry) of one or more of the CU 1910, DU 1930, and the RU 1940. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1902 may include a variety of components configured for various functions. In one configuration, the network entity 1902 includes means for receiving a capability associated with one downlink subband among multiple downlink subbands included in a downlink BWP, where the multiple downlink subbands correspond to a time-domain resource, and means for communicating with the UE using a selected downlink subband from the multiple downlink subbands corresponding to one or more time-domain resources including the first time-domain resource. The downlink BWP may include the multiple downlink subbands. The network entity 1902 may further include means for performing any of the aspects described in connection with the flowcharts in FIG. 16 and FIG. 17, and/or aspects performed by the base station 1304 in FIG. 13. The means may be the component 199 of the network entity 1902 configured to perform the functions recited by the means. As described supra, the network entity 1902 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include reporting, to a network entity, a capability associated with one downlink subband among multiple downlink subbands included in a downlink BWP, where the multiple downlink subbands correspond to a first time-domain resource; and communicating with the network entity using a selected downlink subband from the multiple downlink subbands for one or more time-domain resources including the first time-domain resource. By enabling the use of a single downlink subband for an SBFD-aware UE where multiple downlink subbands are available, the methods ensure broader compatibility across various device types within the network, including UEs with limited processing power or spectrum capability. Additionally, by providing both semi-static and dynamic scheduling options for selecting the single downlink subband, the methods allow flexible adjustment of the single downlink subband based on network conditions and UE capabilities, thereby improving the overall network efficiency and performance. In some examples, by allowing a simpler downlink filtering process on a single downlink subband, compared to using notch filters across multiple subbands, the methods reduce the computational load on the UE.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” or “based on or otherwise in association with” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.”

The following aspects are illustrative only and may be combined with other aspects or teachings described herein, without limitation.
Aspect 1 is a method of wireless communication at a UE. The method includes reporting, to a network entity, a capability associated with one downlink subband among multiple downlink subbands included in a downlink bandwidth part (BWP), where the multiple downlink subbands correspond to a first time-domain resource; and communicating with the network entity using a selected downlink subband from the multiple downlink subbands for one or more time-domain resources including the first time-domain resource.
Aspect 2 is the method of aspect 1, wherein the first time-domain resource includes a subband full duplex (SBFD) symbol or an SBFD slot.
Aspect 3 is the method of any of aspects 1 to 2, wherein the multiple downlink subbands include two downlink subbands separated by an uplink subband, and wherein an unselected downlink subband of the two downlink subbands is not used for communication with the network entity.
Aspect 4 is the method of any of aspects 1 to 3, where communicating with the network entity using the selected downlink subband includes receiving, from the network entity, a data or control signal using the selected downlink subband, wherein the UE is in a radio resource control (RRC) connected state, or performing small data transmission (SDT) with the network entity using the selected downlink subband, wherein the UE is in an RRC idle state or an RRC inactive state.
Aspect 5 is the method of any of aspects 1 to 3, where the method further includes determining one or more usable downlink physical resource blocks (PRBs) based on an intersection of the downlink BWP and the selected downlink subband for the one or more time-domain resources.
Aspect 6 is the method of aspect 5, where communicating with the network entity using the selected downlink subband includes: receiving a channel state information—reference signal (CSI-RS) using the selected downlink subband, and the method further includes: applying a CSI-RS sequence mapping to CSI-RS resources in the one or more usable downlink PRBs in the selected downlink subband from the multiple downlink subbands.
Aspect 7 is the method of aspect 5, wherein communicating with the network entity using the selected downlink subband includes transmitting, to the network entity, a channel state information-reference signal (CSI-RS) report, wherein a CSI reporting subband for the CSI-RS report comprises at least one usable downlink PRB of the one or more usable downlink PRBs, and wherein any CSI reporting subband outside the one or more usable downlink PRBs is not reported in the CSI-RS report.
Aspect 8 is the method of aspect 5, where the method further includes receiving a first resource schedule for a physical downlink shared channel (PDSCH) with a first resource allocation type associated with a bitmap for frequency domain resource allocation (FDRA), wherein the first resource schedule for the PDSCH does not include any resource block group (RBG) outside the one or more usable downlink PRBs.
Aspect 9 is the method of aspect 5, where the method further includes receiving a second resource schedule for a physical downlink shared channel (PDSCH) with a second resource allocation type associated with a resource indication value (RIV) without an interleaving between virtual resource blocks (VRBs) and PRBs, wherein the second resource schedule does not include any PRB outside the one or more usable downlink PRBs.
Aspect 10 is the method of aspect 5, where the method further includes receiving a third resource schedule for a physical downlink shared channel (PDSCH) with a second resource allocation type associated with a resource indication value (RIV) including an interleaving between virtual resource blocks (VRBs) and PRBs; and determining a transport block (TB) size based on valid PRBs, wherein the valid PRBs include the PRBs assigned by the third resource schedule within one usable downlink PRB of the one or more usable downlink PRBs after the interleaving.
Aspect 11 is the method of any of aspects 1 to 3, wherein the capability is a semi-static subband capability, and wherein the selected downlink subband for the one or more time-domain resources are a same downlink subband.
Aspect 12 is the method of aspect 11, where the method further includes receiving, from the network entity, a semi-static configuration comprising a subband indicator for the selected downlink subband for the one or more time-domain resources; and determining the selected downlink subband based on the subband indicator.
Aspect 13 is the method of aspect 11, where the method further includes monitoring PDCCH candidates in search space (SS) of a control resource set (CORESET) on the selected downlink subband, wherein the CORESET spans the multiple downlink subbands.
Aspect 14 is the method of any of aspects 1 to 3, wherein the capability is a dynamic subband capability, and wherein the selected downlink subband for the one or more time-domain resources are different downlink subbands.
Aspect 15 is the method of aspect 14, where the method further includes transmitting, to the network entity, a minimum time period between a change of the selected downlink subband for different time-domain resources.
Aspect 16 is the method of aspect 15, where the method further includes receiving, from the network entity, a subband indicator of the selected downlink subband, wherein the subband indicator is based on one of: a downlink control information (DCI) indication for the selected downlink subband, or a start resource block (RB) for a downlink signal or channel, and the method further includes: determining the selected downlink subband based on the subband indicator.
Aspect 17 is the method of aspect 14, where the method further includes determining the selected downlink subband from the multiple downlink subbands for monitoring physical downlink control channel (PDCCH) candidates in search space (SS) of a control resource set (CORESET); and monitoring the PDCCH candidates in the SS of the CORESET using the one downlink subband, wherein the one downlink subband is determined based on one or more of: common search space (CSS) or synchronization signal block (SSB) in each downlink subband of the multiple downlink subbands, a start resource block (RB) of a first control channel element (CCE) or resource element group (REG) in each downlink subband of the multiple downlink subbands, or a number of CCEs or REGs in each downlink subband of the multiple downlink subbands.
Aspect 18 is an apparatus for wireless communication at a UE, comprising: a processing system that includes processor circuitry and memory circuitry that stores code and is coupled with the processor circuitry, the processing system configured to cause the UE to perform the method of one or more of aspects 1-17.
Aspect 19 is an apparatus for wireless communication at a UE, comprising: at least one memory; and at least one processor coupled to the at least one memory and, where the at least one processor is configured to perform the method of any of aspects 1-17.
Aspect 20 is the apparatus for wireless communication at a UE, comprising means for performing each step in the method of any of aspects 1-17.
Aspect 21 is an apparatus of any of aspects 18-20, further comprising a transceiver configured to receive or to transmit in association with the method of any of aspects 1-17.
Aspect 22 is a computer-readable medium (e.g., a non-transitory computer-readable medium) storing computer executable code at a UE, the code when executed by at least one processor causes the at least one processor to perform the method of any of aspects 1-17.
Aspect 23 is a method of wireless communication at a network entity. The method includes receiving a capability associated with one downlink subband among multiple downlink subbands included in a downlink bandwidth part (BWP), where the multiple downlink subbands correspond to a first time-domain resource; and communicating with a user equipment (UE) using a selected downlink subband from the multiple downlink subbands corresponding to one or more time-domain resources including the first time-domain resource.
Aspect 24 is the method of aspect 23, wherein the time-domain resource includes a subband full duplex (SBFD) symbol or an SBFD slot.
Aspect 25 is the method of any of aspects 23 to 24, wherein the multiple downlink subbands include two downlink subbands separated by an uplink subband, and wherein an unselected downlink subband of the two downlink subbands is not used for communication with the UE.
Aspect 26 is the method of aspect 25, wherein communicating with the UE using the selected downlink subband includes: transmitting, to the UE, a data or control signal using the selected downlink subband, wherein the UE is in a radio resource control (RRC) connected state, or performing small data transmission (SDT) with the UE using the selected downlink subband, wherein the UE is in an RRC idle state or an RRC inactive state.
Aspect 27 is an apparatus for wireless communication at a network entity, comprising: a processing system that includes processor circuitry and memory circuitry that stores code and is coupled with the processor circuitry, the processing system configured to cause the network entity to perform the method of one or more of aspects 23-26.
Aspect 28 is an apparatus for wireless communication at a network entity, comprising: at least one memory; and at least one processor coupled to the at least one memory and, where the at least one processor is configured to perform the method of any of aspects 23-26.
Aspect 29 is the apparatus for wireless communication at a network entity, comprising means for performing each step in the method of any of aspects 23-26.
Aspect 30 is an apparatus of any of aspects 27-29, further comprising a transceiver configured to receive or to transmit in association with the method of any of aspects 23-26.
Aspect 31 is a computer-readable medium (e.g., a non-transitory computer-readable medium) storing computer executable code at a network entity, the code when executed by at least one processor causes the at least one processor to perform the method of any of aspects 23-26.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to cause the UE to:
report, to a network entity, a capability associated with one downlink subband among multiple downlink subbands included in a downlink bandwidth part (BWP), wherein the multiple downlink subbands correspond to a first time-domain resource; and
communicate with the network entity using a selected downlink subband from the multiple downlink subbands for one or more time-domain resources including the first time-domain resource.

2. The apparatus of claim 1, further comprising a transceiver coupled to the at least one processor, wherein to report the capability, the at least one processor is configured to cause the UE to report the capability via the transceiver, and wherein the first time-domain resource includes a subband full duplex (SBFD) symbol or an SBFD slot.

3. The apparatus of claim 2, wherein the multiple downlink subbands include two downlink subbands separated by an uplink subband, and wherein an unselected downlink subband of the two downlink subbands is not used for communication with the network entity.

4. The apparatus of claim 3, wherein to communicate with the network entity using the selected downlink subband, the at least one processor is configured to cause the UE to:
receive, from the network entity, a data or control signal using the selected downlink subband, wherein the UE is in a radio resource control (RRC) connected state, or
performing small data transmission (SDT) with the network entity using the selected downlink subband, wherein the UE is in an RRC idle state or an RRC inactive state.

5. The apparatus of claim 3, wherein the at least one processor is further configured to cause the UE to:
determine one or more usable downlink physical resource blocks (PRBs) based on an intersection of the downlink BWP and the selected downlink subband for the one or more time-domain resources.

6. The apparatus of claim 5, wherein to communicate with the network entity using the selected downlink subband, the at least one processor is configured to cause the UE to:
receive a channel state information-reference signal (CSI-RS) using the selected downlink subband, and wherein the at least one processor is further configured to cause the UE to:
apply a CSI-RS sequence mapping to CSI-RS resources in the one or more usable downlink PRBs in the selected downlink subband from the multiple downlink subbands.

7. The apparatus of claim 5, wherein to communicate with the network entity using the selected downlink subband, the at least one processor is configured to cause the UE to:
transmit, to the network entity, a channel state information-reference signal (CSI-RS) report, wherein a CSI reporting subband for the CSI-RS report comprises at least one usable downlink PRB of the one or more usable downlink PRBs, and wherein any CSI reporting subband outside the one or more usable downlink PRBs is not reported in the CSI-RS report.

8. The apparatus of claim 5, wherein the at least one processor is further configured to cause the UE to:
receive a first resource schedule for a physical downlink shared channel (PDSCH) with a first resource allocation type associated with a bitmap for frequency domain resource allocation (FDRA), wherein the first resource schedule for the PDSCH does not include any resource block group (RBG) outside the one or more usable downlink PRBs.

9. The apparatus of claim 5, wherein the at least one processor is further configured to cause the UE to:
receive a second resource schedule for a physical downlink shared channel (PDSCH) with a second resource allocation type associated with a resource indication value (RIV) without an interleaving between virtual resource blocks (VRBs) and PRBs, wherein the second resource schedule does not include any PRB outside the one or more usable downlink PRBs.

10. The apparatus of claim 5, wherein the at least one processor is further configured to cause the UE to:
receive a third resource schedule for a physical downlink shared channel (PDSCH) with a second resource allocation type associated with a resource indication value (RIV) including an interleaving between virtual resource blocks (VRBs) and PRBs; and
determine a transport block (TB) size based on valid PRBs, wherein the valid PRBs include the PRBs assigned by the third resource schedule within one usable downlink PRB of the one or more usable downlink PRBs after the interleaving.

11. The apparatus of claim 3, wherein the capability is a semi-static subband capability, and wherein the selected downlink subband for the one or more time-domain resources are a same downlink subband.

12. The apparatus of claim 11, wherein the at least one processor is further configured to cause the UE to:
receive, from the network entity, a semi-static configuration comprising a subband indicator for the selected downlink subband for the one or more time-domain resources; and
determine the selected downlink subband based on the subband indicator.

13. The apparatus of claim 11, wherein the at least one processor is further configured to cause the UE to:
monitor physical downlink control channel (PDCCH) candidates in search space (SS) of a control resource set (CORESET) on the selected downlink subband, wherein the CORESET spans the multiple downlink subbands.

14. The apparatus of claim 3, wherein the capability is a dynamic subband capability, and wherein the selected downlink subband for the one or more time-domain resources are different downlink subbands.

15. The apparatus of claim 14, wherein the at least one processor is further configured to cause the UE to:
transmit, to the network entity, a minimum time period between a change of the selected downlink subband for different time-domain resources.

16. The apparatus of claim 15, wherein the at least one processor is further configured to cause the UE to:
receive, from the network entity, a subband indicator of the selected downlink subband, wherein the subband indicator is based on one of:
a downlink control information (DCI) indication for the selected downlink subband, or
a start resource block (RB) for a downlink signal or channel, and
wherein the at least one processor is further configured to cause the UE to:
determine the selected downlink subband based on the subband indicator.

17. The apparatus of claim 14, wherein the at least one processor is further configured to cause the UE to:
determine the selected downlink subband from the multiple downlink subbands for monitoring physical downlink control channel (PDCCH) candidates in search space (SS) of a control resource set (CORESET); and
monitor the PDCCH candidates in the SS of the CORESET using the one downlink subband, wherein the one downlink subband is determined based on one or more of:
common search space (CSS) or synchronization signal block (SSB) in each downlink subband of the multiple downlink subbands,
a start resource block (RB) of a first control channel element (CCE) or resource element group (REG) in each downlink subband of the multiple downlink subbands, or
a number of CCEs or REGs in each downlink subband of the multiple downlink subbands.

18. A method of wireless communication at a user equipment (UE), comprising:
reporting, to a network entity, a capability associated with one downlink subband among multiple downlink subbands included in a downlink bandwidth part (BWP), wherein the multiple downlink subbands correspond to a first time-domain resource; and
communicating with the network entity using a selected downlink subband from the multiple downlink subbands for one or more time-domain resources including the first time-domain resource.

19. The method of claim 18, wherein the first time-domain resource includes a subband full duplex (SBFD) symbol or an SBFD slot.

20. An apparatus for wireless communication at a network entity, comprising:
at least one memory; and
at least one processor coupled to the at least one memory and, based at least in part on information stored in the at least one memory, the at least one processor is configured to cause the network entity to:
receive a capability associated with one downlink subband among multiple downlink subbands included in a downlink bandwidth part (BWP), wherein the multiple downlink subbands correspond to a first time-domain resource; and
communicate with a user equipment (UE) using a selected downlink subband from the multiple downlink subbands corresponding to one or more time-domain resources including the first time-domain resource.
